(19) United States
(12) Patent Application Publication
(10) Pub. No.: US 2025/0261224 A1
(43) Pub. Date: Aug. 14, 2025

(54) BACKHAUL SIGNALING FOR CROSS-LINK INTERFERENCE MITIGATION

(71) Applicant: QUALCOMM Incorporated, San Diego, CA (US)

(72) Inventors: Shankar KRISHNAN, San Diego, CA (US); Muhammad Sayed Khairy ABDELGHAFFAR, San Jose, CA (US); Prasad Reddy KADIRI, San Diego, CA (US); Chiranjib SAHA, Lakeside, CA (US)

(21) Appl. No.: 18/441,438

(22) Filed: Feb. 14, 2024

(51) Int. Cl. H04W 72/541; H04W 24/10; H04W 72/40; H04W 92/18; H04W 92/20

(52) U.S. Cl. CPC H04W 72/541; H04W 24/10; H04W 72/40; H04W 92/18; H04W 92/20

(57) ABSTRACT

Various aspects of the present disclosure generally relate to wireless communication. In some aspects, a user equipment (UE) may receive, from a first network node, an inter-UE cross-link interference (CLI) configuration. The UE may transmit an inter-UE CLI report to the first network node or to a second network node. The CLI configuration may be associated with CLI between UEs (inter-UE CLI), network nodes (inter-gNodeB CLI), or both. Numerous other aspects are described.

### FIELD OF THE DISCLOSURE

Aspects of the present disclosure generally relate to wireless communication and specifically relate to techniques, apparatuses, and methods for backhaul signaling to mitigate cross-link interference.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a first user equipment (UE) includes receiving, from a first network node, an inter-UE cross-link interference (CLI) configuration; and transmitting an inter-UE CLI report to the first network node or to a second network node.

In some aspects, a method of wireless communication performed by a first network node includes transmitting, to a first UE, an inter-UE CLI configuration; transmitting the inter-UE CLI configuration to a second network node serving a second UE; receiving an inter-UE CLI report from the first UE; and transmitting the inter-UE CLI report to the second network node.

In some aspects, a method of wireless communication performed by a first network node includes transmitting, to a first UE, an uplink reference signal configuration; transmitting, to a second network node, the uplink reference signal configuration; receiving an uplink reference signal measurement report from the first UE; and transmitting the uplink reference signal measurement report to the first network node.

In some aspects, a method of wireless communication performed by a first network node includes transmitting an inter-gNB CLI measurement configuration to a second network node; receiving an inter-gNB CLI report from the second network node; and mitigating inter-gNB CLI between the first network node and the second network node.

In some aspects, a method of wireless communication performed by a first network node includes transmitting a reference signal measurement configuration request to a second network node; receiving a reference signal measurement configuration response, the reference signal measurement configuration response including a reference signal measurement configuration for the second network node; measuring a channel using the reference signal measurement configuration response; and transmitting a channel measurement report to the second network node.

In some aspects, a method of wireless communication performed by a first network node includes transmitting a muting request to a second network node; receiving a muting information response from the second network node, the muting information response identifying one or more resources; and transmitting, to a UE, a schedule for communicating via the resources identified in the muting information response.

In some aspects, a first UE for wireless communication includes one or more memories; and one or more processors, coupled to the one or more memories, configured to cause the UE to: receive, from a first network node, an inter-UE CLI configuration; and transmit an inter-UE CLI report to the first network node or to a second network node.

In some aspects, a first network node for wireless communication includes one or more memories; and one or more processors, coupled to the one or more memories, configured to cause the first network node to: transmit, to a first UE, an inter-UE CLI configuration; transmit the inter-UE CLI configuration to a second network node serving a second UE; receive an inter-UE CLI report from the first UE; and transmit the inter-UE CLI report to the second network node.

In some aspects, a first network node for wireless communication includes one or more memories; and one or more processors, coupled to the one or more memories, configured to cause the first network node to: transmit, to a first UE, an uplink reference signal configuration; transmit, to a second network node, the uplink reference signal configuration; receive an uplink reference signal measurement report from the first UE; and transmit the uplink reference signal measurement report to the first network node.

In some aspects, a first network node for wireless communication includes one or more memories; and one or more processors, coupled to the one or more memories, configured to cause the first network node to: transmit an inter-gNB CLI measurement configuration to a second network node; receive an inter-gNB CLI report from the second network node; and mitigate inter-gNB CLI between the first network node and the second network node.

In some aspects, a first network node for wireless communication includes one or more memories; and one or more processors, coupled to the one or more memories, configured to cause the first network node to: transmit a reference signal measurement configuration request to a second network node; receive a reference signal measurement configuration response, the reference signal measurement configuration response including a reference signal measurement configuration for the second network node; measure a channel using the reference signal measurement configuration response; and transmit a channel measurement report to the second network node.

In some aspects, a first network node for wireless communication includes one or more memories; and one or more processors, coupled to the one or more memories, configured to cause the first network node to: transmit a muting request to a second network node; receive a muting information response from the second network node, the muting information response identifying one or more resources; and transmit, to a UE, a schedule for communicating via the resources identified in the muting information response.

In some aspects, a non-transitory computer-readable medium storing a set of instructions for wireless communication includes one or more instructions that, when executed by one or more processors of a first UE, cause the UE to: receive, from a first network node, an inter-UE CLI configuration; and transmit an inter-UE CLI report to the first network node or to a second network node.

In some aspects, a non-transitory computer-readable medium storing a set of instructions for wireless communication includes one or more instructions that, when executed by one or more processors of a first network node, cause the first network node to: transmit, to a first UE, an inter-UE CLI configuration; transmit the inter-UE CLI configuration to a second network node serving a second UE; receive an inter-UE CLI report from the first UE; and transmit the inter-UE CLI report to the second network node.

In some aspects, a non-transitory computer-readable medium storing a set of instructions for wireless communication includes one or more instructions that, when executed by one or more processors of a first network node, cause the first network node to: transmit, to a first UE, an uplink reference signal configuration; transmit, to a second network node, the uplink reference signal configuration; receive an uplink reference signal measurement report from the first UE; and transmit the uplink reference signal measurement report to the first network node.

In some aspects, a non-transitory computer-readable medium storing a set of instructions for wireless communication includes one or more instructions that, when executed by one or more processors of a first network node, cause the first network node to: transmit an inter-gNB CLI measurement configuration to a second network node; receive an inter-gNB CLI report from the second network node; and mitigate inter-gNB CLI between the first network node and the second network node.

In some aspects, a non-transitory computer-readable medium storing a set of instructions for wireless communication includes one or more instructions that, when executed by one or more processors of a first network node, cause the first network node to: transmit a reference signal measurement configuration request to a second network node; receive a reference signal measurement configuration response, the reference signal measurement configuration response including a reference signal measurement configuration for the second network node; measure a channel using the reference signal measurement configuration response; and transmit a channel measurement report to the second network node.

In some aspects, a non-transitory computer-readable medium storing a set of instructions for wireless communication includes one or more instructions that, when executed by one or more processors of a first network node, cause the first network node to: transmit a muting request to a second network node; receive a muting information response from the second network node, the muting information response identifying one or more resources; and transmit, to a UE, a schedule for communicating via the resources identified in the muting information response.

In some aspects, an apparatus for wireless communication includes means for receiving, from a first network node, an inter-UE CLI configuration; and means for transmitting an inter-UE CLI report to the first network node or to a second network node.

In some aspects, an apparatus for wireless communication includes means for transmitting, to a first UE, an inter-UE CLI configuration; means for transmitting the inter-UE CLI configuration to a network node serving a second UE; means for receiving an inter-UE CLI report from the first UE; and means for transmitting the inter-UE CLI report to the second network node.

In some aspects, an apparatus for wireless communication includes means for transmitting, to a first UE, an uplink reference signal configuration; means for transmitting, to a network node, the uplink reference signal configuration; means for receiving an uplink reference signal measurement report from the first UE; and means for transmitting the uplink reference signal measurement report to the first network node.

In some aspects, an apparatus for wireless communication includes means for transmitting an inter-gNB CLI measurement configuration to a second network node; means for receiving an inter-gNB CLI report from the second network node; and means for mitigating inter-gNB CLI between the apparatus and a network node.

In some aspects, an apparatus for wireless communication includes means for transmitting a reference signal measurement configuration request to a second network node; means for receiving a reference signal measurement configuration response, the reference signal measurement configuration response including a reference signal measurement configuration for the second network node; means for measuring a channel using the reference signal measurement configuration response; and means for transmitting a channel measurement report to the second network node.

In some aspects, an apparatus for wireless communication includes means for transmitting a muting request to a second network node; means for receiving a muting information response from the second network node, the muting information response identifying one or more resources; and means for transmitting, to a UE, a schedule for communicating via the resources identified in the muting information response.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description May enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating examples of radio access networks, in accordance with the present disclosure.

FIG. 5 is a diagram illustrating an example of an integrated access and backhaul (IAB) network architecture, in accordance with the present disclosure.

FIG. 6 is a diagram illustrating an example relating to cross-link interference (CLI) detection and mitigation, in accordance with the present disclosure.

FIG. 7 is a diagram illustrating an example associated with backhaul signaling to mitigate inter-UE CLI, in accordance with the present disclosure.

FIG. 8 is a diagram illustrating an example associated with co-existence between a Layer 1/Layer 2 (L1/L2) inter-UE CLI configuration and a Layer (L3) inter-UE CLI configuration, in accordance with the present disclosure.

FIG. 9 is a diagram illustrating an example associated with co-existence between an L1/L2 inter-UE CLI configuration and an L3 inter-UE CLI configuration, in accordance with the present disclosure.

FIG. 10 is a diagram illustrating an example associated with mitigating inter-gNodeB CLI, in accordance with the present disclosure.

FIG. 11 is a diagram illustrating an example associated with backhaul support for inter-gNB channel measurements, in accordance with the present disclosure.

FIG. 12 is a diagram illustrating an example associated with backhaul signaling for exchanging muting information, in accordance with the present disclosure.

FIG. 13 is a diagram illustrating an example process performed, for example, at a UE or an apparatus of a UE, in accordance with the present disclosure.

FIGS. 14-18 are diagrams illustrating example processes performed, for example, at a network node or an apparatus of a network node, in accordance with the present disclosure.

FIG. 19 is a diagram of an example apparatus for wireless communication, in accordance with the present disclosure.

FIG. 20 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Backhaul signaling occurs when data is transmitted from cell sites to a core network and vice versa. Cross-link interference (CLI) can occur when transmissions by multiple network devices, such as network nodes (e.g., gNodeBs (gNBs) or user equipments (UEs)) interfere with one another. CLI can degrade network performance, reduce data rates, and increase error rates, which in turn affects the quality of service experienced by end-users. Network devices are unable to mitigate CLI if the network devices are unaware that the CLI is happening. Backhaul signaling provides one way for network nodes to detect and prevent CLI between network nodes, UEs, and/or a combination thereof, among other examples.

Various aspects relate generally to using backhaul signaling for CLI mitigation. Some aspects more specifically relate to CLI configurations that configure a UE to transmit an inter-UE CLI report to a network node. The inter-UE CLI report may represent CLI between multiple UEs, such as an aggressor UE and a victim UE. The aggressor UE is the UE causing the CLI and the victim UE is the UE affected by the CLI. In some aspects, the network node may communicate the CLI configuration, the inter-UE CLI report, or both, to other network nodes, such as the network node servicing the aggressor UE, the victim UE, or both.

Particular aspects of the subject matter described in this disclosure can be implemented to realize one or more of the following potential advantages. In some examples, by implementing an inter-UE CLI configuration, the described techniques can be used to control one or more UEs in a way that may reduce inter-UE CLI. In some examples, by implementing an inter-gNB CLI configuration, the described techniques can be used to mitigate inter-gNB CLI. Mitigating inter-UE CLI and/or inter-gNB CLI may result in improved network performance, improved data rates, and decreased error rates.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

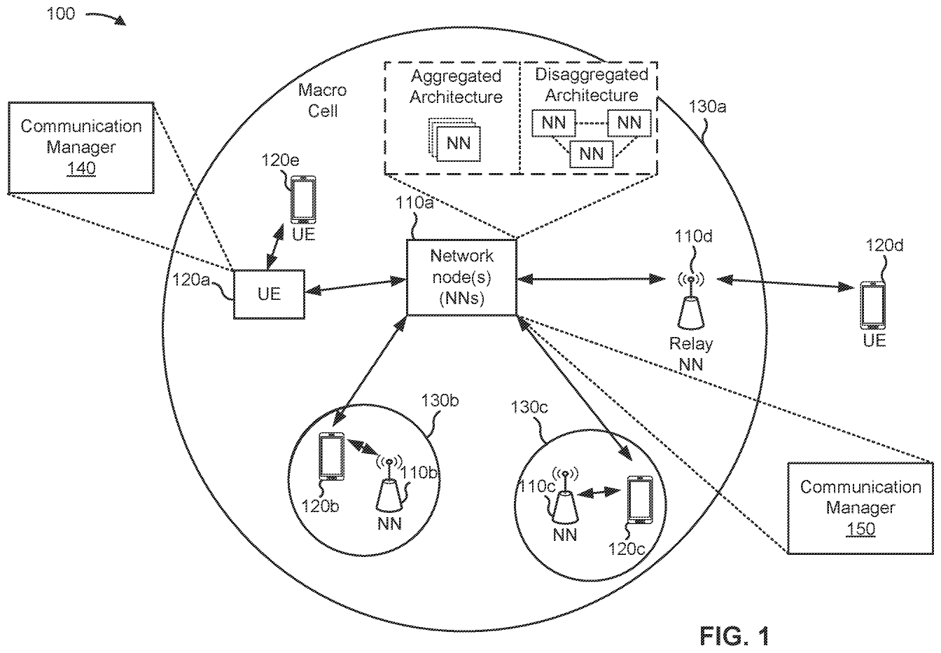

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a first network node, an inter-UE CLI configuration; and transmit an inter-UE CLI report to the first network node or to a second network node. Additionally, or alternatively, the communication manager 140 may perform one or more other operations described herein.

In some aspects, the network node 110 may include a communication manager 150. As described in more detail elsewhere herein, the communication manager 150 may transmit, to a first UE, an inter-UE CLI configuration; transmit the inter-UE CLI configuration to a second network node serving a second UE; receive an inter-UE CLI report from the first UE; and transmit the inter-UE CLI report to the second network node.

In some aspects, as described in more detail elsewhere herein, the communication manager 150 may transmit, to a first UE, an uplink reference signal configuration; transmit, to a second network node, the uplink reference signal configuration; receive an uplink reference signal measurement report from the first UE; and transmit the uplink reference signal measurement report to the first network node.

In some aspects, as described in more detail elsewhere herein, the communication manager 150 may transmit an inter-gNB CLI measurement configuration to a second network node; receive an inter-gNB CLI report from the second network node; and mitigate inter-gNB CLI between the first network node and the second network node.

In some aspects, as described in more detail elsewhere herein, the communication manager 150 may transmit a reference signal measurement configuration request to a second network node; receive a reference signal measurement configuration response, the reference signal measurement configuration response including a reference signal measurement configuration for the second network node; measure a channel using the reference signal measurement configuration response; and transmit a channel measurement report to the second network node.

In some aspects, as described in more detail elsewhere herein, the communication manager 150 may transmit a muting request to a second network node; receive a muting information response from the second network node, the muting information response identifying one or more resources; and transmit, to a UE, a schedule for communicating via the resources identified in the muting information response. Additionally, or alternatively, the communication manager 150 may perform one or more other operations described herein.

As indicated above, FIG. 1 is provided as an example. Other examples may differ from what is described with regard to FIG. 1.

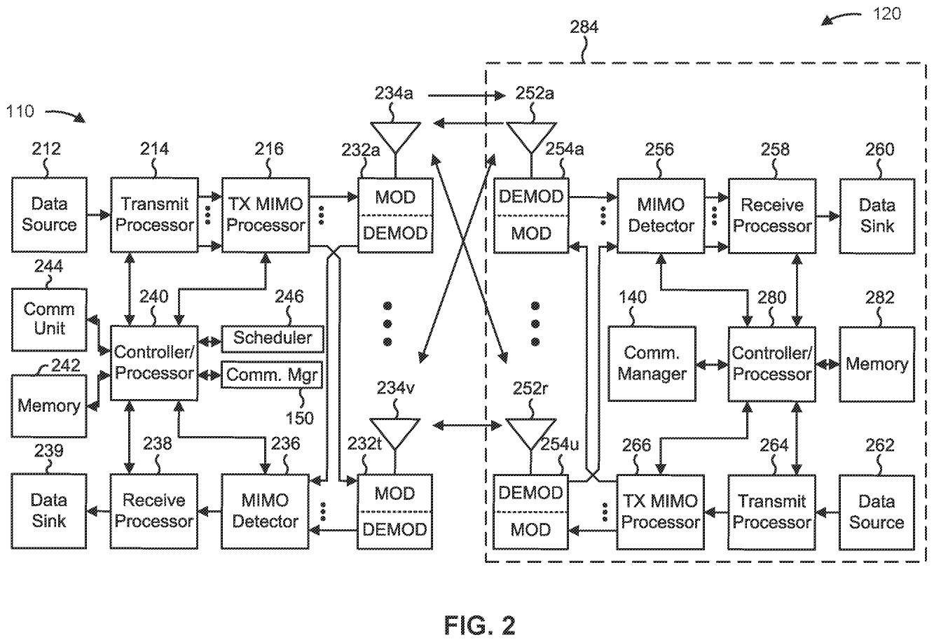

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

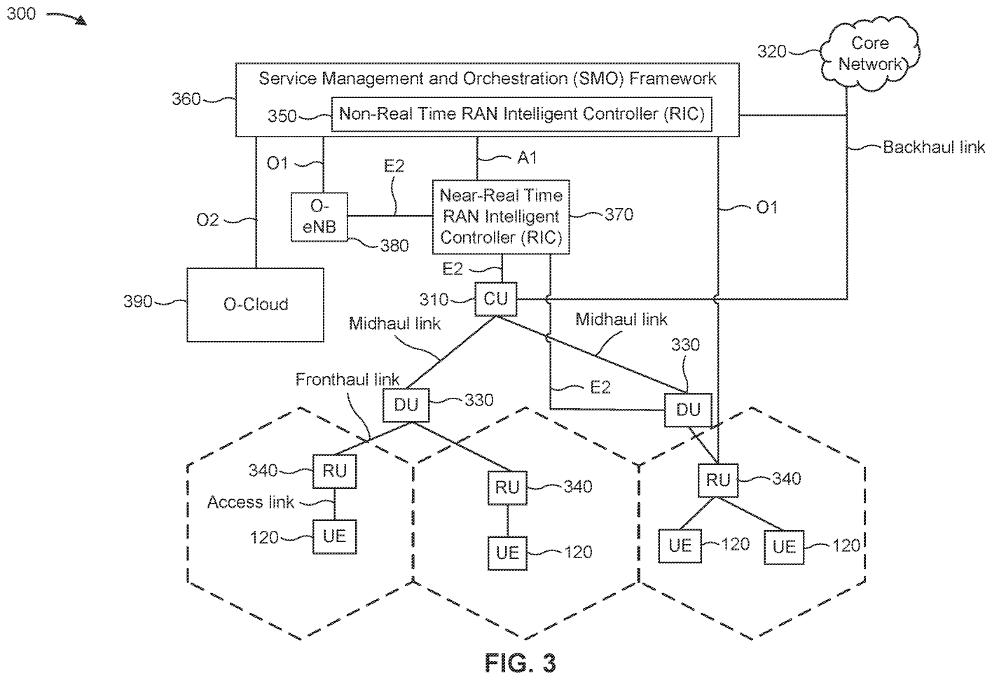

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

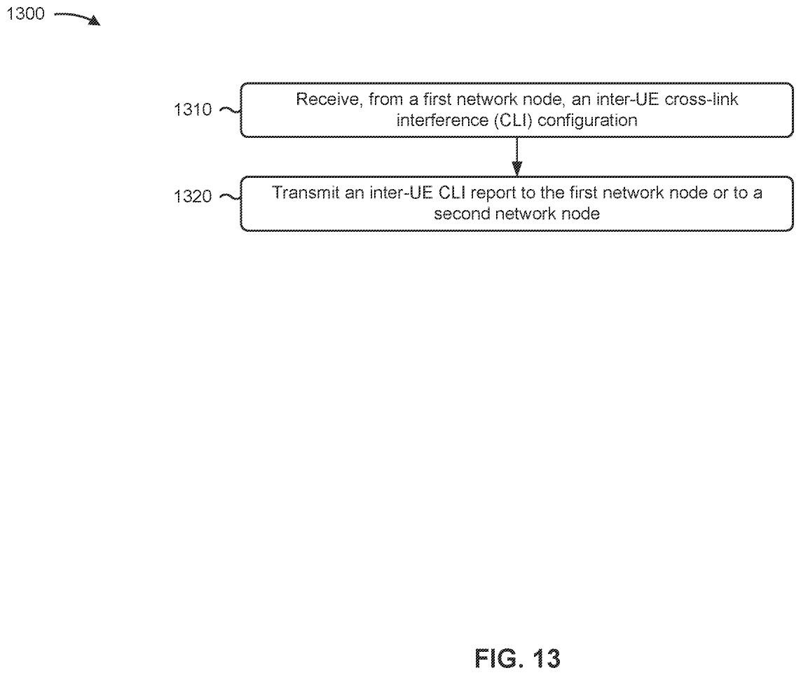

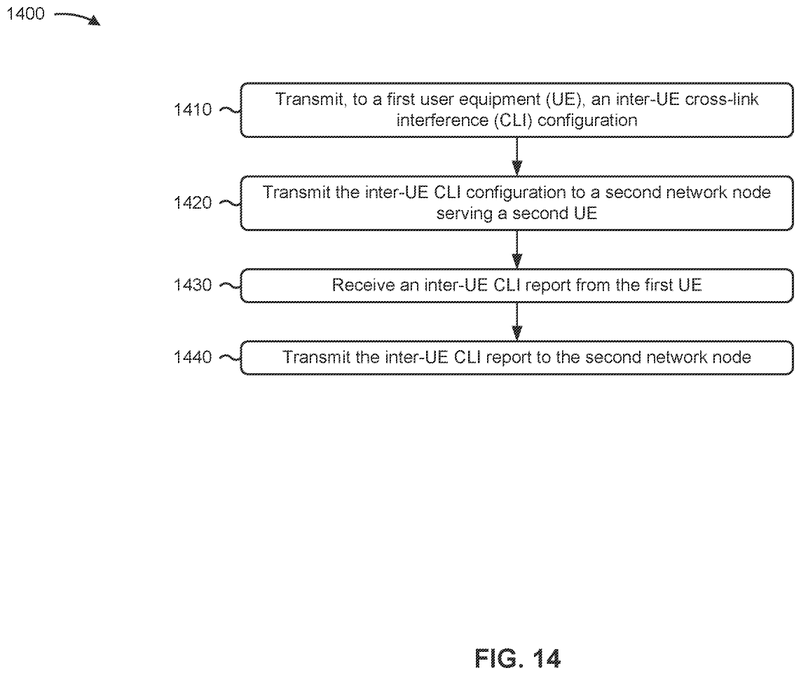

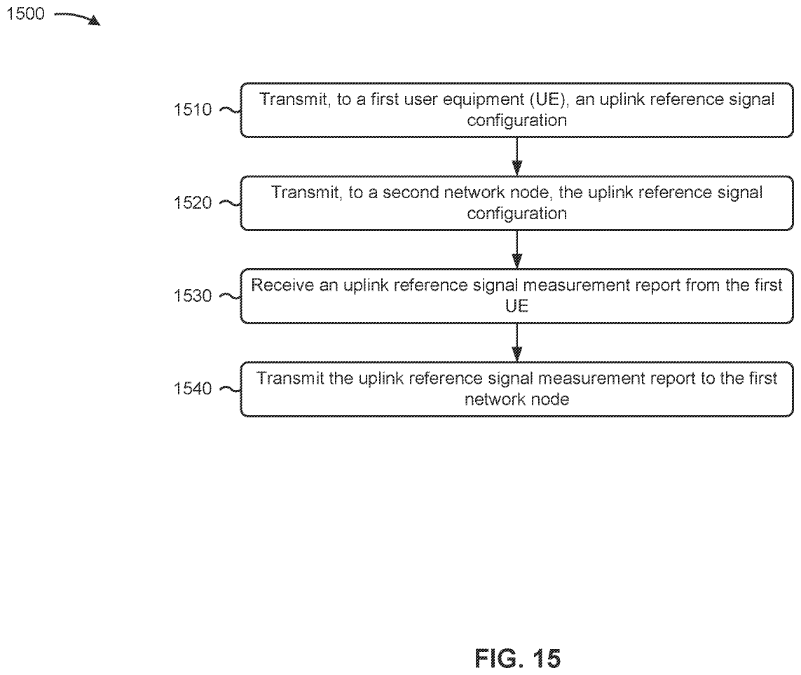

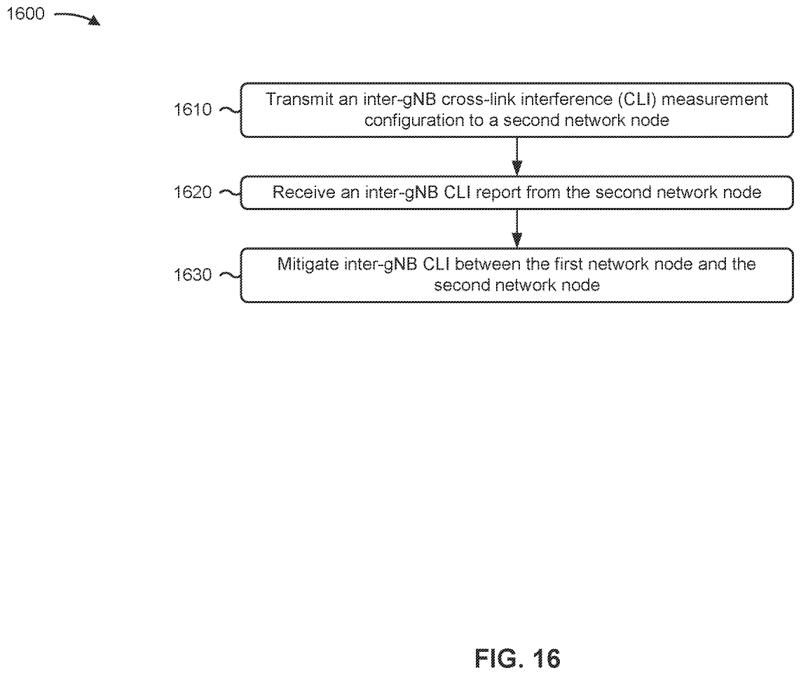

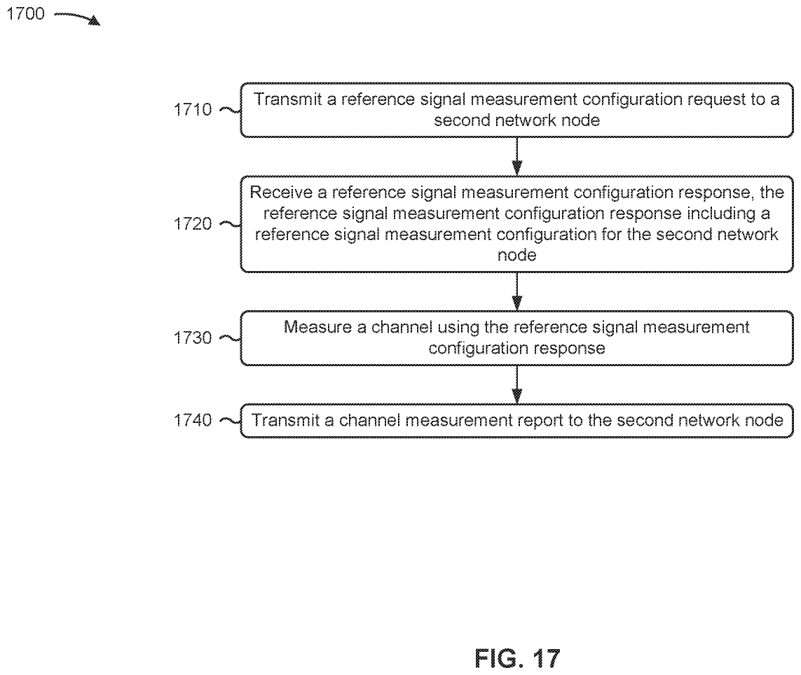

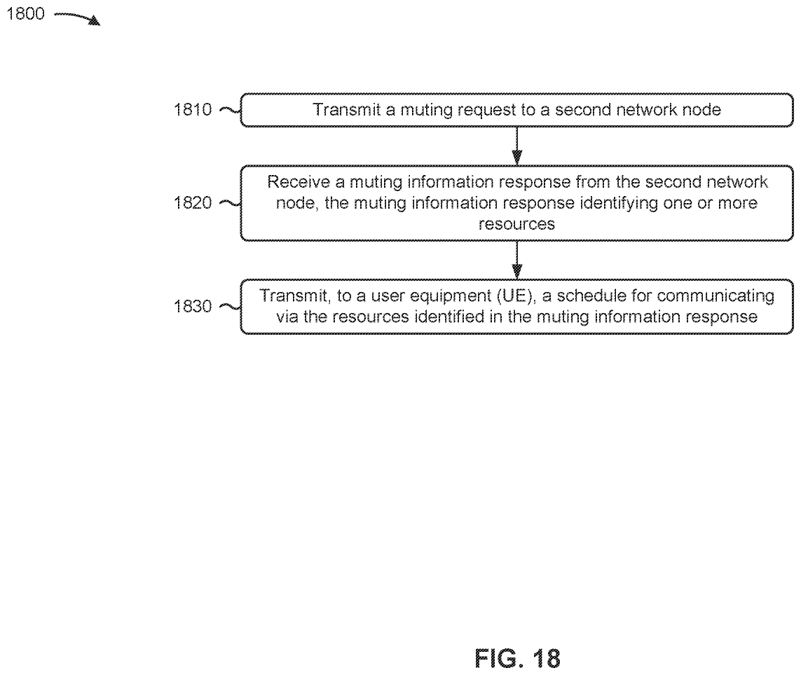

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with backhaul signaling to mitigate CLI, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1300 of FIG. 13, process 1400 of FIG. 14, process 1500 of FIG. 15, process 1600 of FIG. 16, process 1700 of FIG. 17, process 1800 of FIG. 18, or other processes as described herein (alone or in conjunction with one or more other processors). The memory 242 may store data and program codes for the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13, process 1400 of FIG. 14, process 1500 of FIG. 15, process 1600 of FIG. 16, process 1700 of FIG. 17, process 1800 of FIG. 18, or other processes as described herein. In some examples, executing instructions may include running the instructions, converting the instructions, compiling the instructions, and/or interpreting the instructions, among other examples.

In some aspects, a UE (e.g., a UE 120) includes means for receiving, from a first network node (e.g., a network node 110), an inter-UE CLI configuration; and/or means for transmitting an inter-UE CLI report to the first network node or to a second network node. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for transmitting, to a first UE, an inter-UE CLI configuration; means for transmitting the inter-UE CLI configuration to a second network node serving a second UE; means for receiving an inter-UE CLI report from the first UE; and/or means for transmitting the inter-UE CLI report to the second network node.

In some aspects, the network node includes means for transmitting, to a first UE, an uplink reference signal configuration; means for transmitting, to a second network node, the uplink reference signal configuration; means for receiving an uplink reference signal measurement report from the first UE; and/or means for transmitting the uplink reference signal measurement report to the first network node.

In some aspects, the network node includes means for transmitting an inter-gNB CLI measurement configuration to a second network node; means for receiving an inter-gNB CLI report from the second network node; and/or means for mitigating inter-gNB CLI between the first network node and the second network node.

In some aspects, the network node includes means for transmitting a reference signal measurement configuration request to a second network node; means for receiving a reference signal measurement configuration response, the reference signal measurement configuration response including a reference signal measurement configuration for the second network node; means for measuring a channel using the reference signal measurement configuration response; and/or means for transmitting a channel measurement report to the second network node.

In some aspects, the network node includes means for transmitting a muting request to a second network node; means for receiving a muting information response from the second network node, the muting information response identifying one or more resources; and/or means for transmitting, to a UE, a schedule for communicating via the resources identified in the muting information response. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

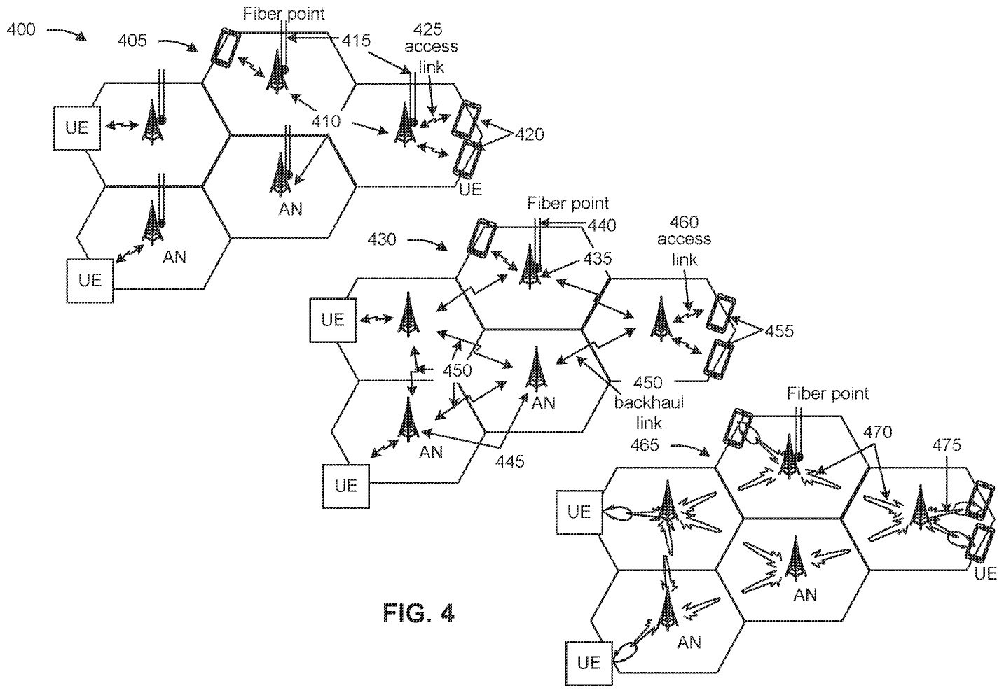

FIG. 4 is a diagram illustrating examples 400 of radio access networks, in accordance with the present disclosure.

As shown by reference number 405, a traditional (e.g., 3G, 4G, or LTE) radio access network may include multiple base stations 410 (e.g., access nodes (AN)), where each base station 410 communicates with a core network via a wired backhaul link 415, such as a fiber connection. A base station 410 may communicate with a UE 420 via an access link 425, which may be a wireless link. In some aspects, a base station 410 shown in FIG. 4 may be network node 110 shown in FIG. 1. In some aspects, a UE 420 shown in FIG. 4 may be a UE 120 shown in FIG. 1.

As shown by reference number 430, a radio access network may include a wireless backhaul network, sometimes referred to as an integrated access and backhaul (IAB) network. In an IAB network, at least one base station is an anchor base station 435 that communicates with a core network via a wired backhaul link 440, such as a fiber connection. An anchor base station 435 may also be referred to as an IAB donor (or IAB-donor). The IAB network may include one or more non-anchor base stations 445, sometimes referred to as relay base stations or IAB nodes (or IAB-nodes). The non-anchor base station 445 may communicate directly or indirectly with the anchor base station 435 via one or more backhaul links 450 (e.g., via one or more non-anchor base stations 445) to form a backhaul path to the core network for carrying backhaul traffic. Backhaul link 450 may be a wireless link. Anchor base station(s) 435 and/or non-anchor base station(s) 445 may communicate with one or more UEs 455 via access links 460, which may be wireless links for carrying access traffic. In some aspects, an anchor base station 435 and/or a non-anchor base station 445 shown in FIG. 4 may be a network node110 shown in FIG. 1. In some aspects, a UE 455 shown in FIG. 4 may be a UE 120 shown in FIG. 1.

As shown by reference number 465, in some aspects, a radio access network that includes an IAB network may utilize millimeter wave technology and/or directional communications (e.g., beamforming) for communications between base stations and/or UEs (e.g., between two base stations, between two UEs, and/or between a base station and a UE). For example, wireless backhaul links 470 between base stations may use millimeter wave signals to carry information and/or may be directed toward a target base station using beamforming. Similarly, the wireless access links 475 between a UE and a base station may use millimeter wave signals and/or may be directed toward a target wireless node (e.g., a UE and/or a base station). In this way, inter-link interference may be reduced.

The configuration of base stations and UEs in FIG. 4 is shown as an example, and other examples are contemplated. For example, one or more base stations illustrated in FIG. 4 may be replaced by one or more UEs that communicate via a UE-to-UE access network (e.g., sidelink, a peer-to-peer network, or a device-to-device network). In this case, an anchor node may refer to a UE that is directly in communication with a base station (e.g., an anchor base station or a non-anchor base station).

As indicated above, FIG. 4 is provided as an example. Other examples may differ from what is described with regard to FIG. 4.

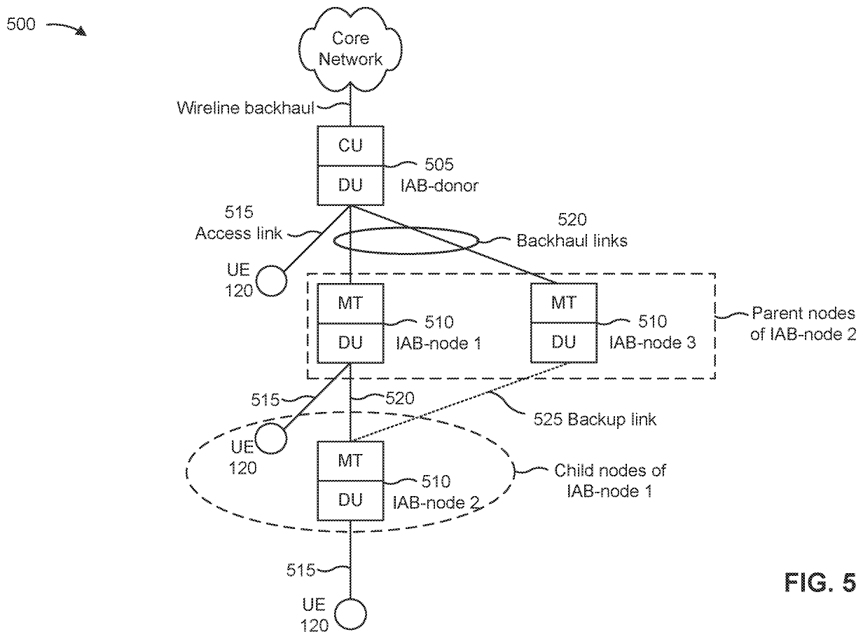

FIG. 5 is a diagram illustrating an example 500 of an IAB network architecture, in accordance with the present disclosure.

As shown in FIG. 5, an IAB network may include an IAB donor 505 (shown as IAB-donor) that connects to a core network via a wired connection (shown as a wireline backhaul). For example, an Ng interface of an IAB donor 505 may terminate at a core network. Additionally, or alternatively, an IAB donor 505 may connect to one or more devices of the core network that provide a core access and mobility management function (e.g., AMF). In some aspects, an IAB donor 505 may include a network node 110, such as an anchor base station, as described above in connection with 4. As shown, an IAB donor 505 may include a CU, which may perform access node controller (ANC) functions and/or AMF functions. The CU may configure a DU of the IAB donor 505 and/or may configure one or more IAB nodes 510 (e.g., an MT and/or a DU of an IAB node 510) that connect to the core network via the IAB donor 505. Thus, a CU of an IAB donor 505 may control and/or configure the entire IAB network that connects to the core network via the IAB donor 505, such as by using control messages and/or configuration messages (e.g., an RRC configuration message or an F1 application protocol (F1-AP) message).

As further shown in FIG. 5, the IAB network may include IAB nodes 510 (shown as IAB-node 1, IAB-node 2, and IAB-node 3) that connect to the core network via the IAB donor 505. As shown, an IAB node 510 may include mobile termination (MT) functions (also sometimes referred to as UE functions (UEF)) and may include DU functions (also sometimes referred to as access node functions (ANF)). The MT functions of an IAB node 510 (e.g., a child node) may be controlled and/or scheduled by another IAB node 510 (e.g., a parent node of the child node) and/or by an IAB donor 505. The DU functions of an IAB node 510 (e.g., a parent node) may control and/or schedule other IAB nodes 510 (e.g., child nodes of the parent node) and/or UEs 120. Thus, a DU may be referred to as a scheduling node or a scheduling component, and an MT may be referred to as a scheduled node or a scheduled component. In some aspects, an IAB donor 505 may include DU functions and not MT functions. That is, an IAB donor 505 may configure, control, and/or schedule communications of IAB nodes 510 and/or UEs 120. A UE 120 may include only MT functions, and not DU functions. That is, communications of a UE 120 may be controlled and/or scheduled by an IAB donor 505 and/or an IAB node 510 (e.g., a parent node of the UE 120).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor 505 or an IAB node 510, and a child node may be an IAB node 510 or a UE 120. Communications of an MT function of a child node may be controlled and/or scheduled by a parent node of the child node.

As further shown in FIG. 5, a link between a UE 120 (e.g., which only has MT functions, and not DU functions) and an IAB donor 505, or between a UE 120 and an IAB node 510, may be referred to as an access link 515. Access link 515 may be a wireless access link that provides a UE 120 with radio access to a core network via an IAB donor 505, and optionally via one or more IAB nodes 510. Thus, the network illustrated in 5 may be referred to as a multi-hop network or a wireless multi-hop network.

As further shown in FIG. 5, a link between an IAB donor 505 and an IAB node 510 or between two IAB nodes 510 may be referred to as a backhaul link 520. Backhaul link 520 may be a wireless backhaul link that provides an IAB node 510 with radio access to a core network via an IAB donor 505, and optionally via one or more other IAB nodes 510. In an IAB network, network resources for wireless communications (e.g., time resources, frequency resources, and/or spatial resources) may be shared between access links 515 and backhaul links 520. In some aspects, a backhaul link 520 may be a primary backhaul link or a secondary backhaul link (e.g., a backup backhaul link). In some aspects, a secondary backhaul link may be used if a primary backhaul link fails, becomes congested, and/or becomes overloaded, among other examples. For example, a backup link 525 between IAB-node 2 and IAB-node 3 may be used for backhaul communications if a primary backhaul link between IAB-node 2 and IAB-node 1 fails. As used herein, a node or a wireless node may refer to an IAB donor 505 or an IAB node 510.

As indicated above, FIG. 5 is provided as an example. Other examples may differ from what is described with regard to FIG. 5.

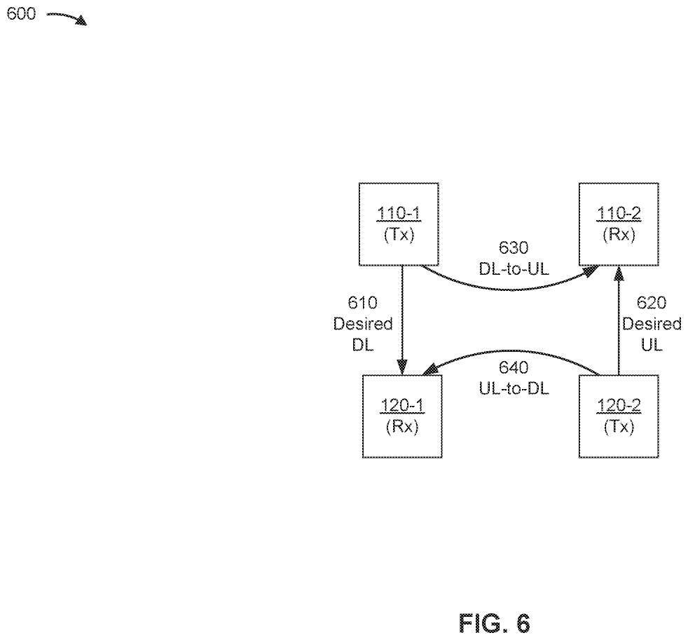

FIG. 6 is a diagram illustrating an example 600 relating to cross-link interference detection and mitigation, in accordance with the present disclosure.

In dynamic time division duplexing (TDD), the allocation of network resources to uplink and downlink may be dynamically modified depending on a traffic load. For example, a network node 110 may configure a TDD configuration (e.g., a TDD pattern) with more uplink transmission time intervals (TTIs) (e.g., frames, subframes, slots, mini-slots, and/or symbols) for a UE 120 when the UE 120 has uplink data to transmit, and may configure a TDD configuration with more downlink TTIs for the UE 120 when the UE 120 has downlink data to receive. The TDD configuration may be dynamically configured to modify the allocation of uplink TTIs and downlink TTIs used for communication between the network node 110 and the UE 120.

Alternatively, the UE 120 may be configured with a sub-band full duplex (SBFD) configuration, which may allow the UE 120 to transmit and receive signals simultaneously within different sub-bands of the same frequency band.

As shown in FIG. 6, when neighboring network nodes 110 use different TDD configurations or SBFD configurations to communicate with UEs 120, this may result in a downlink communication 610 between a first network node 110-1 and a first UE 120-1 in a same TTI as an uplink communication 620 between a second network node 110-2 and a second UE 120-2. These communications in different transmission directions (e.g., downlink vs. uplink) in the same TTI may interfere with one another, which may be referred to as cross-link interference.

For example, as shown by reference number 630, the downlink communication 610 transmitted by the first network node 110-1 may be received by the second network node 110-2, and may interfere with reception, by the second network node 110-2, of the uplink communication 620 from the second UE 120-2. This may be referred to as downlink-to-uplink (DL-to-UL) interference, network node to network node interference, or gNB-to-gNB interference.

Further, as shown by reference number 640, the uplink communication 620 transmitted by the second UE 120-2 may be received by the first UE 120-1, and may interfere with reception, by the first UE 120-1, of the downlink communication 610 from the first network node 110-1. This may be referred to as uplink-to-downlink (UL-to-DL) interference or UE-to-UE interference. This UE to UE interference may occur and/or may increase when the first UE 120-1 and the second UE 120-2 are in close proximity, and may be avoided or mitigated by preventing scheduling of the UEs 120 in different transmission directions in the same TTI.

In the case of UE-to-UE interference (inter-UE CLI), the UE causing the interference (e.g., the receiving (Rx) UE when CLI is caused by downlink communications or the transmitting (Tx) UE when the CLI is caused by uplink communications) may be referred to as the aggressor UE. The UE experiencing interference (e.g., another UE near the aggressor UE) may be referred to as the victim UE. In the case of network-node-to-network-node CLI (e.g., inter-gNB CLI), the network node causing the interference (the Tx networking node for downlink communications or the Rx network node for uplink communications) may be referred to as the aggressor network node. The network node experiencing interference caused by the aggressor network node may be referred to as a victim network node.

As indicated above, FIG. 6 is provided as an example. Other examples are possible and may differ from what was described with respect to FIG. 6.

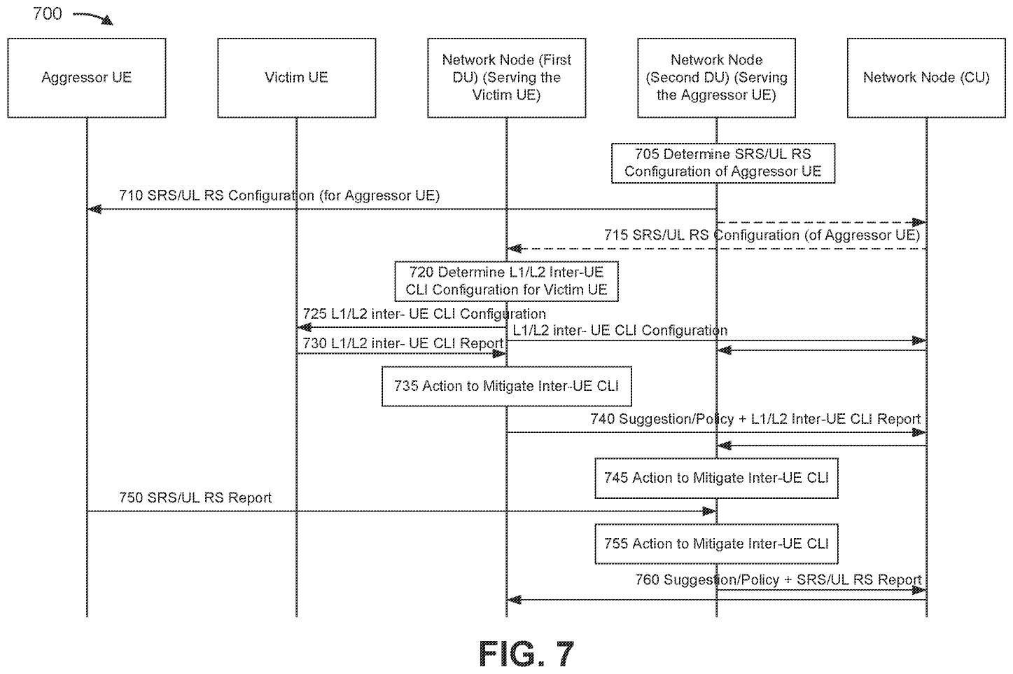

FIG. 7 is a diagram illustrating an example 700 associated with backhaul signaling to mitigate inter-UE CLI, in accordance with the present disclosure. As shown in FIG. 7, multiple network nodes (each being, e.g., an instance of network node 110 including a CU or DU) and multiple UEs (each being, e.g., an instance of UE 120, such as an aggressor UE or a victim UE) may communicate with one another. For example, a first DU may serve a victim UE, a second DU may serve an aggressor UE, and a CU may be in communication with both the first DU and the second DU.

As shown by reference number 705, the second DU may determine an SRS/uplink (UL) reference signal (RS) configuration of the aggressor UE. As shown by reference number 710, the second DU may transmit the SRS/UL RS configuration to the aggressor UE. Alternatively or in addition, the second DU may transmit the SRS/UL RS configuration to the CU. The SRS/UL RS configuration may be transmitted to the aggressor UE directly by the second DU via downlink MAC-CE, DCI, or other Layer 1/Layer 2 (L1/L2) signaling. In some aspects, the SRS/UL RS configuration may be transmitted from the second DU to the CU via the F1 application protocol (F1AP), and the CU may transmit the SRS/UL RS configuration to the aggressor UE via RRC signaling. The second DU may transmit the SRS/UL RS configuration to the CU autonomously or in response to a request from the CU. As shown by reference number 715, the CU may transmit the SRS/UL RS configuration for the aggressor UE to the first DU. The CU may transmit the SRS/UL RS configuration to the first DU either autonomously or upon request from the first DU. The identifier of the DU and the identifier of the cell may be included when forwarding the SRS/UL RS configuration from the second DU to the CU, and vice versa. The communications between the CU and the first DU and the CU and the second DU may be through F1AP or an Xn application protocol (XnAP).

As shown by reference number 720, the first DU may determine the L1/L2 inter-UE CLI configuration (e.g., an inter-UE CLI configuration transmitted via L1/L2 signaling) for the victim UE. The first DU may determine the L1/L2 inter-UE CLI configuration autonomously or after receiving assistance from other network nodes (e.g., after receiving the SRS/UL RS configuration). The inter-UE CLI configuration may include a CLI measurement config identifier, a type of CLI measurement to perform (RSSI/RSRP), CLI resource details, CLI resource type (periodic (P)/aperiodic (AP)/semi-persistent (SP) resource), CLI measurement periodicity, an event trigger for the CLI measurement, reporting periodicity, a reporting event trigger, frequency resources (resource block group (RBG)/sub-band to measure CLI), spatial resources (e.g., which beams/transmission configuration indicator (TCI) to measure, whether the beams can be synchronization signal block (SSB) and/or CSI-RS). In some aspects, the inter-UE CLI configuration may be an L1/L2 based inter-UE CLI configuration or an L3-based inter-UE CLI configuration (e.g., an inter-UE CLI configuration transmitted via L3 signaling), as discussed in greater detail below.

As shown by reference number 725, the first DU may transmit the L1/L2 inter-UE CLI configuration to the victim UE, to the second DU via the CU, and/or a combination thereof, among other examples. The L1/L2 inter-UE CLI configuration may be transmitted to the victim UE via MAC-CE, DCI, or another L1/L2 signaling. For communications between the first DU and the CU, the CU may transmit the L1/L2 inter-UE CLI configuration to the second DU either autonomously or upon request from the second DU. The identifier of the DU and the identifier of the cell may be included when forwarding the L1/L2 inter-UE CLI configuration from the CU to the second DU, and vice versa. The communications between the CU and the first DU and the CU and the second DU may be via F1AP or XnAP.

As shown by reference number 730, the victim UE may transmit an L1/L2 inter-UE CLI report to the first DU. The victim UE may transmit the L1/L2 inter-UE CLI report to the first DU over an uplink MAC-CE, UCI, or other L1/L2 signaling. The signaling for the L1/L2 inter-UE CLI report may include a CLI measurement configuration identifier, the CLI measurements, a UE identifier, a beam identifier, an aggressor sub-band identifier, and/or a combination thereof, among other examples.

As shown by reference number 735, the first DU may be configured to take an action to mitigate the inter-UE CLI. For example, the first DU may avoid scheduling the victim UE in time or frequency resources with high inter-UE CLI (e.g., the first DU may schedule time or frequency resources, for the victim UE, only associated with low inter-UE CLI).

Another possible action, shown by reference number 740, is that the first DU may forward the L1/L2 inter-UE CLI reports and/or providing a suggestion or policy to the second DU, via the CU over F1AP/XnAP, so that the second DU may take action to avoid inter-UE CLI, as shown by reference number 745. For example, the second DU may be configured to configure the aggressor UE to reduce a Tx power. Alternatively or in addition, the second DU may be configured to reduce its own Tx power when, for example, scheduling the aggressor UE. As shown by reference number 750, the aggressor UE may transmit, and the second DU may receive, an SRS/UL RS report. As shown by reference number 755, in response to the SRS/UL RS report, the second DU may be configured to take an action to mitigate the inter-UE CLI. For example, the second DU may be configured to determine whether there is potentially high inter-UE CLI based on the SRS measurements and take action to mitigate the inter-UE CLI (e.g., reduce a Tx power, as discussed above). As shown by reference number 760, the second DU may forward a CLI-mitigation suggestion or CLI-mitigation policy to the first DU via the CU over F1AP/XnAP. In some aspects, the second DU may additionally or alternatively forward the SRS/UL RS report received from the aggressor UE. With respect to reference numbers 740 and 760, the suggestions and/or policies can include recommendations on power backoff, Tx/Rx beams to use, a guard band to use, timing adjustments, an indication of the most/least aggressor UE(s), an indication of the most/least interfering beam(s), and/or a combination thereof, among other examples. The first DU and/or the second DU can determine the suggestions and/or policies autonomously or via the inter-UE CLI reports/SRS reports obtained from the UEs (e.g., the cyclic shift/frequency resources used in the SRS report can indicate which UE is the most/least aggressor UE(s), which beam most/least interfering beam(s), etc.). Further, the suggestions and/or policies can also directly come from the UE (e.g., the UE can recommend a guard band to be used for the SBFD configuration to the gNB which can then be forwarded among network nodes).

As indicated above, FIG. 7 is provided as an example. Other examples may differ from what is described with respect to FIG. 7.

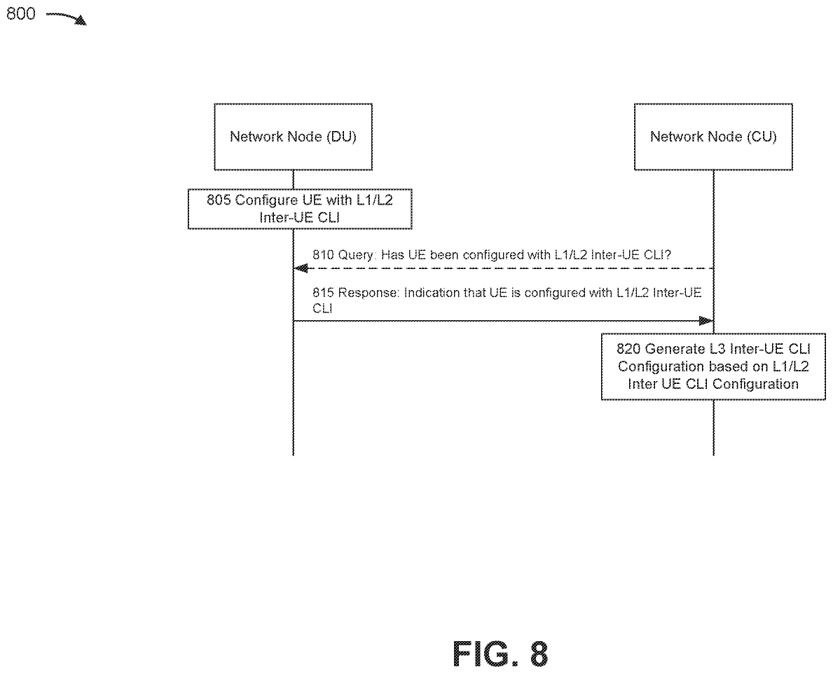

FIG. 8 is a diagram illustrating an example 800 associated with co-existence between an L1/L2 inter-UE CLI configuration and an L3 CLI configuration, in accordance with the present disclosure. As shown in FIG. 8, a DU (e.g., an instance of network node 110) and a CU (e.g., another instance of network node 110) may communicate with one another.

As shown by reference number 805, the DU may configure a UE (such as UE 120) with an L1/L2 inter-UE CLI configuration.

As shown by reference number 810, the CU may transmit a query to the DU. The query may request an indication of whether or not the UE has been configured with the L1/L2 inter-UE CLI configuration.

As shown by reference number 815, the DU may transmit an indication that the UE has been configured with the L1/L2 inter-UE CLI configuration. The indication may be transmitted in response to the query shown by reference number 810. The indication may include a flag, a UE identifier (e.g., a F1AP identifier or a cell radio network temporary identifier (C-RNTI), among other examples), some or all of the L1/L2 inter-UE CLI configuration, and/or a combination thereof, among other examples. In some aspects, the indication may include only a CLI measurement configuration identifier. In some aspects, the indication may be transmitted to the CU autonomously or upon the query (reference number 810) from the DU.

As shown by reference number 820, the CU may generate an L3 inter-UE CLI configuration. In some aspects, the CU may configure the UE with the L3 inter-UE CLI configuration based on the L1/L2 inter-UE CLI configuration. In some aspects, with respect to reference number 820, the CU may avoid configuring the UE with the L3 inter-UE CLI configuration if the UE has already been configured with the L1/L2 inter-UE CLI configuration to, for example, avoid duplicate inter-UE CLI configurations.

As indicated above, FIG. 8 is provided as an example. Other examples may differ from what is described with respect to FIG. 8.

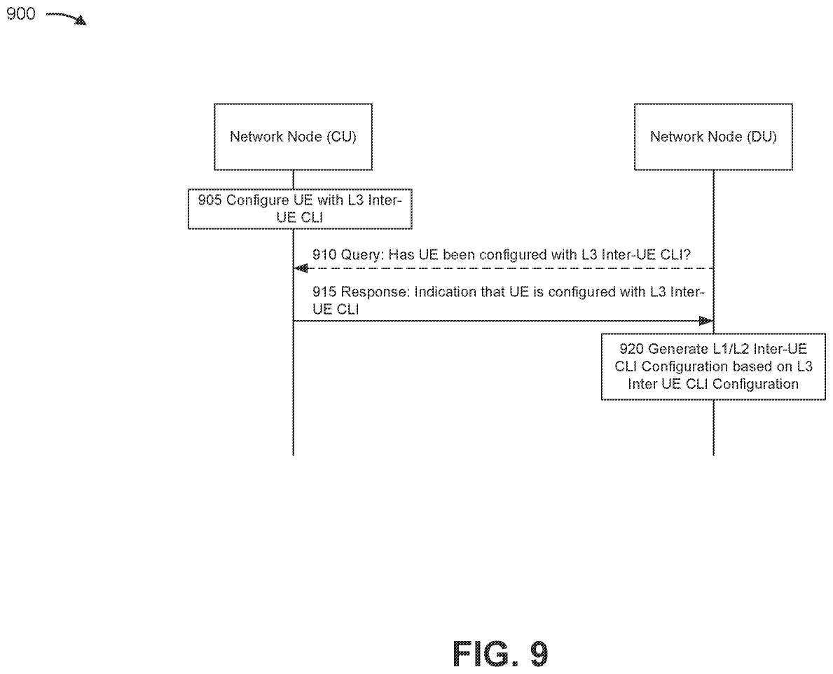

FIG. 9 is a diagram illustrating an example 900 associated with co-existence between an L1/L2 inter-UE CLI configuration and an L3 CLI configuration, in accordance with the present disclosure. As shown in FIG. 9, a DU (e.g., an instance of network node 110) and a CU (e.g., another instance of network node 110) may communicate with one another.

As shown by reference number 905, the CU may configure a UE (such as UE 120) with an L3 inter-UE CLI configuration.

As shown by reference number 910, the DU may transmit a query to the CU. The query may request an indication of whether or not the UE has been configured with the L3 inter-UE CLI configuration.

As shown by reference number 915, the CU may transmit an indication that the UE has been configured with the L3 inter-UE CLI configuration. The indication may be transmitted in response to the query shown by reference number 910. The indication may include a flag, a UE identifier (e.g., an FIAP identifier or a C-RNTI, among other examples), some or all of the L3 inter-UE CLI configuration, and/or a combination thereof, among other examples. In some aspects, the indication may include only a CLI measurement configuration identifier. In some aspects, the indication may be transmitted to the DU autonomously or upon the query (reference number 910) from the CU.

As shown by reference number 920, the DU may generate an L1/L2 inter-UE CLI configuration. In some aspects, the DU may configure the UE with the L1/L2 inter-UE CLI configuration based on the L3 inter-UE CLI configuration. In some aspects, with respect to reference number 920, the DU may avoid configuring the UE with the L1/L2 inter-UE CLI configuration if the UE has already been configured with the L3 inter-UE CLI configuration to, for example, avoid duplicate inter-UE CLI configurations.

As indicated above, FIG. 9 is provided as an example. Other examples may differ from what is described with respect to FIG. 9.

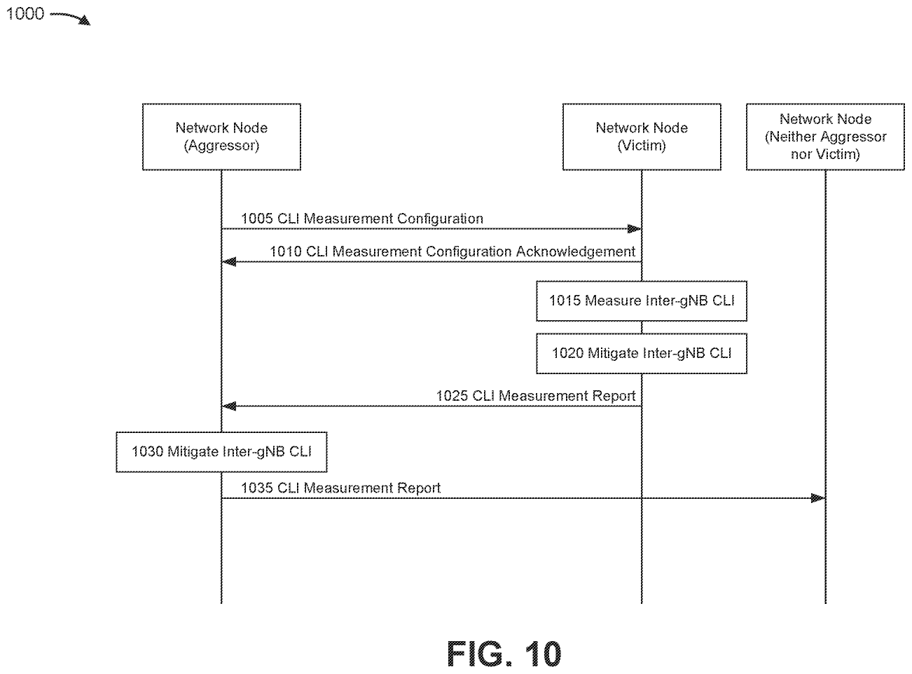

FIG. 10 is a diagram illustrating an example 1000 associated with mitigating inter-gNB CLI, in accordance with the present disclosure. As shown in FIG. 10, an aggressor network node (e.g., an instance of network node 110), a victim network node (e.g., another instance of network node 110, different from the aggressor network node), and a separate network node (e.g., another instance of network node 110 different from the aggressor network node and the victim network node) may communicate with one another.

As shown by reference number 1005, the aggressor network node may transmit, and the victim network node may receive, a CLI measurement configuration. The CLI measurement configuration may request a CLI report and/or policy from the victim network node, one or both of which may be used to mitigate inter-gNB CLI. The inter-gNB CLI measurement configuration may include a CLI measurement configuration identifier, details about one or more CLI measurement resource(s), CLI measurement trigger(s), a CLI measurement periodicity, CLI measurement window(s), a CLI measurement type (e.g., RSRP/RSSI), CLI reporting trigger(s), an indication of whether to measure leakage, direct interference, or both, an indication of whether the CLI measurement can be filtered or needs to be instantaneous, and/or a combination thereof, among other examples. In some aspects, the CLI measurement resource may include details of time resources (e.g., which slots/symbols/subframes in which to measure CLI), frequency resources (e.g., RBG/sub-bands on which to measure CLI), spatial resources (e.g., which beams/TCI to measure CLI), and/or a combination thereof, among other examples. In some aspects, the CLI measurement resource can be a list of SSBs, CSI-RS resources, and/or PDCCH/PDSCH DMRS resources on which to measure CLI. The SSB may be a case-D SSB (CD-SSB) or a non-CD SSB (NCD-SSB). The CSI-RS resources may be a CSI interference measurement (CSI-IM), a zero power CSI-RS (ZP-CSI-RS), or non-ZP CSI-RS (NZP-CSI-RS). In some aspects, the CLI measurement resources may be periodic, aperiodic, or semi-persistent resources.

As shown by reference number 1010, the victim network node may transmit, and the aggressor network node may receive, a CLI measurement acknowledgement. The CLI measurement acknowledgement may confirm, to the aggressor network node, that the victim network node received the CLI measurement configuration, discussed above with respect to reference number 1005.

As shown by reference number 1015, the victim network node may measure inter-gNB CLI. In some aspects, the CLI may be measured upon an event occurring. For example, the CLI may be measured as a result of a radio strength of a measurement resource being above a threshold or being below a threshold.

As shown by reference number 1020, the victim network node may take an action to mitigate inter-gNB CLI. For example, the victim network node may be configured to avoid scheduling resources associated with high CLI (e.g., the victim network node may be configured to only schedule resources associated with low CLI).

As shown by reference number 1025, the victim network node may transmit, and the aggressor network node may receive, an inter-gNB CLI report. The inter-gNB CLI report may include inter-gNB CLI measurements, a CLI measurement configuration identifier, a gNB identifier, a beam identifier, a sub-band identifier (the gNB identifier, the beam identifier, and/or the sub-band identifier being associated with the gNB, beam, and/or sub-band on which the inter-gNB CLI was measured), a most or least aggressor sub-band identifier, most-least aggressor gNB(s), most-least interfering beam(s), an indication of whether the CLI measured was caused by leakage, direct interference, or both, an indication about the type of CLI reported (e.g., RSSI/RSRP), and/or a combination thereof, among other examples. In some aspects, any suggestions and/or policies transmitted with the inter-gNB CLI report may include suggestions, recommendations, and/or requests on power backoff, preferences (e.g., preferred, non-preferred, and/or restricted) for Tx and/or Rx beams, a guard band to use, a timing adjustment, and/or a combination thereof, among other examples. The aggressor network node may be configured to accept, reject, or partially accept the suggestions and/or policies.

The CLI may be reported periodically or upon occurrence of a triggering event (e.g., if the measured radio strength or CLI is above or below a threshold).

As shown by reference number 1030, the aggressor network node may take an action to mitigate the inter-gNB CLI. For example, the aggressor network node may be configured to reduce its Tx power.

As shown by reference number 1035, the aggressor network node may transmit, and the separate network node may receive, a CLI measurement report. For example, the aggressor network node may forward the CLI measurement report, received from the victim network node, to the separate network node. In some aspects, as discussed above, any suggestions and/or policies transmitted with the inter-gNB CLI report may include suggestions, recommendations, and/or requests on power backoff, preferences (e.g., preferred, non-preferred, and/or restricted) for Tx and/or Rx beams, a guard band to use, a timing adjustment, and/or a combination thereof, among other examples. The separate network node may be configured to accept, reject, or partially accept the suggestions and/or policies.

In some aspects, the aggressor network node, the victim network node, and the separate network node may be CUs, DUs, and/or any combination thereof, among other examples. In case of a split network architecture, the DU associated with the aggressor network node may be configured to determine the inter-gNB CLI measurement configuration. In some aspects, the inter-gNB CLI configuration and inter-gNB CLI reports may be exchanged between neighboring network nodes (including between neighboring DUs via the CU). In some aspects, the DU may be configured to forward the inter-gNB CLI configuration and/or inter-gNB CLI reports to the CU either autonomously or upon request from the CU. The receiving CU may be configured to forward the inter-gNB CLI configuration and/or inter-gNB CLI report to one or more other DUs either autonomously or upon request from the one or more other DUs. The inter-gNB CLI configuration and/or the inter-gNB CLI reports may be transmitted in a UE-assisted or non-UE assisted manner (e.g., by aggregating reports of multiple network nodes in a single message).

As indicated above, FIG. 10 is provided as an example. Other examples may differ from what is described with respect to FIG. 10.

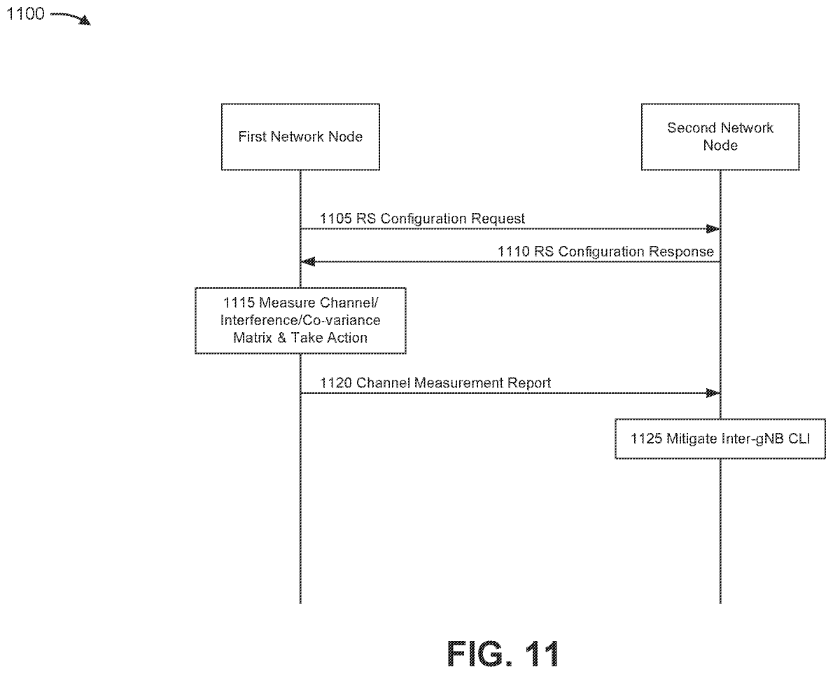

FIG. 11 is a diagram illustrating an example 1100 associated with backhaul support for inter-gNB channel measurements, in accordance with the present disclosure. As shown in FIG. 11, a first network node (e.g., an instance of network node 110) and a second network node (e.g., another instance of network node 110) may communicate with one another. The first network node may be an aggressor network node or a network node serving an aggressor UE, and the second network node may be a victim network node or a network node serving a victim UE. Alternatively, the first network node may be a victim network node or a network node serving a victim UE, and the second network node may be an aggressor network node or a network node serving an aggressor UE.

As shown by reference number 1105, the first network node may transmit, and the second network node may receive, an RS configuration request. The RS configuration request may indicate a transaction identifier for the RS configuration exchange, which RS configurations are requested (e.g., all or specific RS configurations such as SSB and/or CSI-RS), when the RS configurations should be reported (e.g., periodically or upon an event trigger), and/or a combination thereof, among other examples.

As shown by reference number 1110, the second network node may transmit, and the first network node may receive, an RS configuration response. The RS configuration response may indicate a transaction identifier for the RS configuration exchange, details about the requested RS configuration, and/or a combination thereof, among other examples. The details about the requested RS may include a type of RS (e.g., SSB, CSI-RS, PDCCH/PDSCH DMRS, and/or a combination thereof, among other examples). As discussed above, the RS type may include CD-SSB or NCD-SSB for SSBs. The RS type for CSI-RS may include CSI-IM, ZP-CSI-RS, NZP-CSI-RS, and/or a combination thereof, among other examples. Further, the details may include whether the RS configuration is a periodic, aperiodic, or semi-persistent resource. In some aspects, the details about the requested RS configuration may include details about the RS resources, such as details about the time resources, the frequency resources, and/or the spatial resources associated with the transmission of the RS. In some aspects, the details about the requested RS configuration may include an RS Tx trigger (either periodic or event triggered), which may include the RS periodicity if the RS is a periodic resource. In some aspects, the details about the requested RS configuration may include details about the RS measurement such as RS measurement type (e.g., RSSI and/or RSRP), one or more RS measurement triggers, an RS measurement window, and/or a combination thereof, among other examples.

As shown by reference number 1115, the first network node may measure the channel, CLI, or covariance matrix. In some aspects, the first network node make an action to mitigate inter-gNB CLI. For example, the first network node may perform Tx nulling or beamforming. In some aspects, the first network node may perform resource muting on the resources used by the second network node.

As shown by reference number 1120, the first network node may transmit, and the second network node may receive, a channel measurement report. In some aspects, the channel measurement report may include a channel measurement, a covariance matrix, and/or a combination thereof, among other examples. For example, the channel measurement report may include an estimated and/or measured channel, an interference, a covariance matrix, and/or details about the channel measurement methodology. Examples of channel measurement methodology may include a gNB identifier, a beam identifier, a sub-band identifier, etc., associated with the RS measurements. The RS measurement report may be reported periodically, upon a triggering event, upon request from the second network node, and/or a combination thereof, among other examples. In some aspects, the RS measurement report is reported a single time.

As shown by reference number 1125, the second network node may be configured to take steps to mitigate the inter-gNB CLI. The steps taken to mitigate the inter-gNB CLI may be based on the channel measurement report. Examples of steps may include reducing a Tx power, scheduling resources to reduce inter-gNB CLI, and/or a combination thereof, among other examples.

As indicated above, FIG. 11 is provided as an example. Other examples may differ from what is described with respect to FIG. 11.

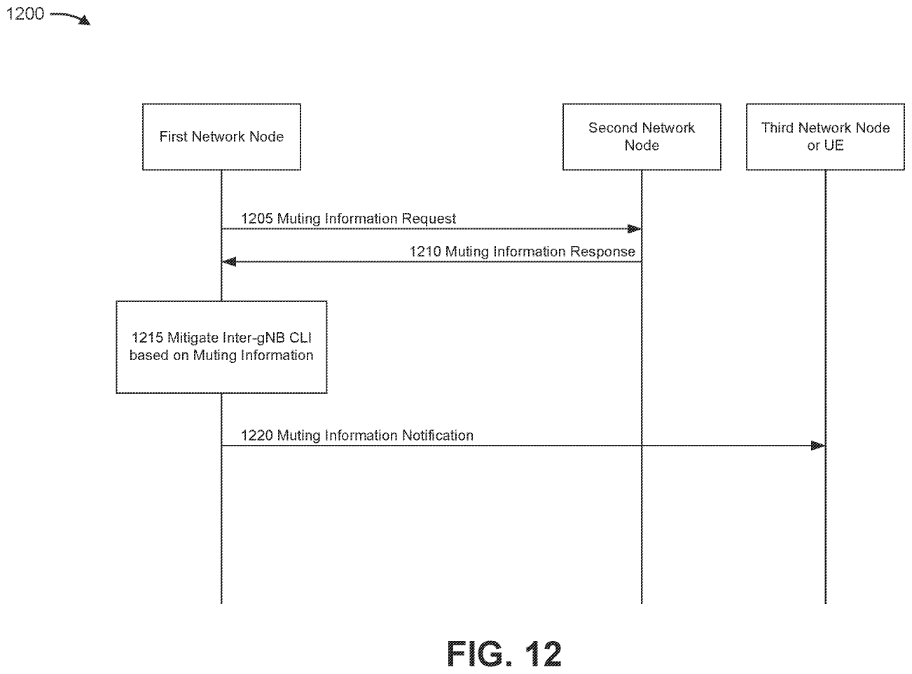

FIG. 12 is a diagram illustrating an example 1200 associated with backhaul signaling for exchanging muting information, in accordance with the present disclosure. As shown in FIG. 12, a first network node (e.g., an instance of network node 110), a second network node (e.g., another instance of network node 110, different from the first network node), and a third network node (e.g., another instance of network node 110 different from the first network node and the second network node) or a UE (such as UE 120) may communicate with one another. In some aspects, the first network node, the second network node, and the third network node may be CUs, DUs, and/or any combination thereof, among other examples.

As shown by reference number 1205, the first network node may transmit, and the second network node may receive, a muting information request. The muting information request may request muting information about time, frequency, and/or spatial resources. In some aspects, the muting information request may request that certain time, frequency, and/or spatial resources be muted. In some aspects, the muting information request may request information associated with specific cells, beams, UEs, and/or a combination thereof, among other examples.

As shown by reference number 1210, the second network node may transmit, and the first network node may receive, a muting information response. The muting information response may provide the requested muted information, discussed above with respect to reference number 1205. For example, the muting information response may indicate time and/or frequency resources which are muted, rate-matched, and/or punctured. In some aspects, the muting information response may indicate spatial resources (e.g., one or more SSBs and/or CSI-RSs) that are nulled and/or beam-formed. The muting information response may be cell-specific, beam-specific, UE-specific, area-specific, and/or a combination thereof, among other examples. In some aspects, the muting information may indicate a muting pattern. The muting pattern may be indicated via bitmap (e.g., which may indicate which resources are muted). In some aspects, the muting pattern may indicate whether a whole resource set (within a period) is muted or only the repetition of the resource set (within the period) is muted. In some aspects, the muting information may be provided autonomously or upon request from the second network node. In some aspects, the second network node may be configured to accept, reject, or partially accept the muting information request.

As shown by reference number 1215, the first network node may be configured to take an action based on the muting information. For example, the first network node may be configured to schedule UEs in resources which are muted by the second network node.

As shown by reference number 1220, the first network node may transmit a muting information notification to the third network node or to the UE. The muting information notification may include the muting information from the second network node or actions taken by the first network node in response to the muting information. The muting information notification, when provided to a UE, may be transmitted to the UE via a system information block (SIB), RRC signaling, and/or L1/L2 signaling (e.g., DCI, MAC-CE, among other examples). In some aspects, the muting information further includes muting information associated with served cells and neighboring cells, which may be the same as or different from the second network node. In the case of forwarding the muting information to the third network node, the third network node may be a CU or DU.

As indicated above, FIG. 12 is provided as an example. Other examples may differ from what is described with respect to FIG. 12.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with backhaul signaling to mitigate inter-UE CLI.

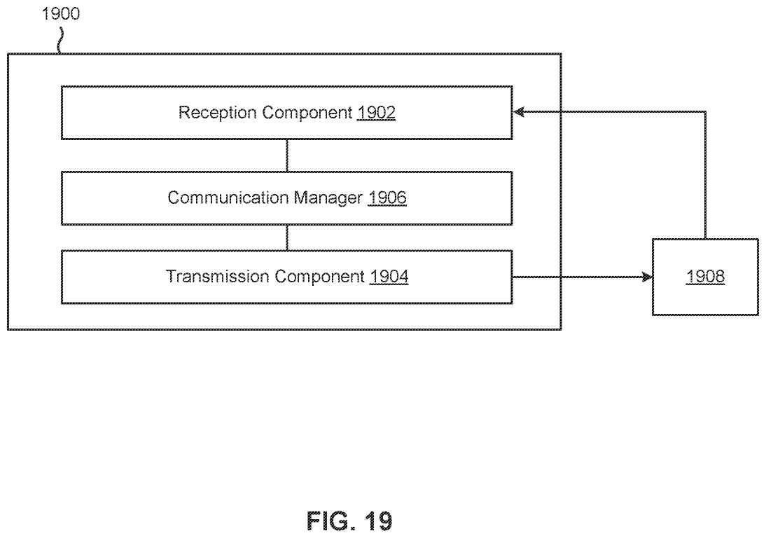

As shown in FIG. 13, in some aspects, process 1300 may include receiving, from a first network node, an inter-UE CLI configuration (block 1310). For example, the UE (e.g., using reception component 1902 and/or communication manager 1906, depicted in FIG. 19) may receive, from a first network node, an inter-UE CLI configuration, as described above.

As further shown in FIG. 13, in some aspects, process 1300 may include transmitting an inter-UE CLI report to the first network node or to a second network node (block 1320). For example, the UE (e.g., using transmission component 1904 and/or communication manager 1906, depicted in FIG. 19) may transmit an inter-UE CLI report to the first network node or to a second network node, as described above.

Process 1300 may include additional aspects, such as any single aspect or any combination of aspects described below and/or in connection with one or more other processes described elsewhere herein.

In a first aspect, the inter-UE CLI configuration includes rules for measuring interference between the first UE and a second UE, and the inter-UE CLI configuration is received via L1/L2 signaling.

In a second aspect, alone or in combination with the first aspect, the inter-UE CLI report is associated with interference between the first UE and a second UE, and the inter-UE CLI report is transmitted to the first network node or to the second network node via L1/L2 signaling.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a first network node or an apparatus of a first network node, in accordance with the present disclosure. Example process 1400 is an example where the apparatus or the first network node (e.g., first network node 110) performs operations associated with backhaul signaling to mitigate inter-UE CLI.

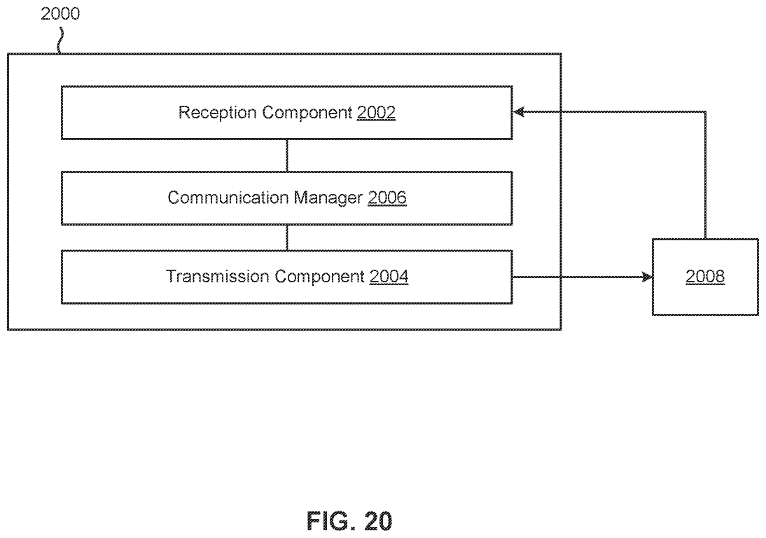

As shown in FIG. 14, in some aspects, process 1400 may include transmitting, to a first UE, an inter-UE CLI configuration (block 1410). For example, the first network node (e.g., using transmission component 2004 and/or communication manager 2006, depicted in FIG. 20) may transmit, to a first UE, an inter-UE CLI configuration, as described above.

As further shown in FIG. 14, in some aspects, process 1400 may include transmitting the inter-UE CLI configuration to a second network node serving a second UE (block 1420). For example, the first network node (e.g., using transmission component 2004 and/or communication manager 2006, depicted in FIG. 20) may transmit the inter-UE CLI configuration to a second network node serving a second UE, as described above.

As further shown in FIG. 14, in some aspects, process 1400 may include receiving an inter-UE CLI report from the first UE (block 1430). For example, the first network node (e.g., using reception component 2002 and/or communication manager 2006, depicted in FIG. 20) may receive an inter-UE CLI report from the first UE, as described above.

As further shown in FIG. 14, in some aspects, process 1400 may include transmitting the inter-UE CLI report to the second network node (block 1440). For example, the first network node (e.g., using transmission component 2004 and/or communication manager 2006, depicted in FIG. 20) may transmit the inter-UE CLI report to the second network node, as described above.

Process 1400 may include additional aspects, such as any single aspect or any combination of aspects described below and/or in connection with one or more other processes described elsewhere herein.

In a first aspect, process 1400 includes granting, to the first UE, resources associated with low inter-UE CLI.

In a second aspect, alone or in combination with the first aspect, process 1400 includes receiving, from the second network node, an SRS configuration or UL RS configuration for the second UE.

In a third aspect, alone or in combination with one or more of the first and second aspects, process 1400 includes determining the inter-UE CLI configuration in accordance with the SRS or UL RS configuration for the second UE.

In a fourth aspect, alone or in combination with one or more of the first through third aspects, process 1400 includes transmitting, to the second network node, the inter-UE CLI report.

In a fifth aspect, alone or in combination with one or more of the first through fourth aspects, process 1400 includes transmitting, to the second network node, the inter-UE CLI configuration.

In a sixth aspect, alone or in combination with one or more of the first through fifth aspects, process 1400 includes transmitting, to the second network node, a mitigation policy.

In a seventh aspect, alone or in combination with one or more of the first through sixth aspects, the mitigation policy identifies one or more of a power backoff, one or more transmit beams, one or more receive beams, a guard band, a timing adjustment, one or more aggressor UEs, a most interfering beam, or a least interfering beam.

In an eighth aspect, alone or in combination with one or more of the first through seventh aspects, process 1400 includes transmitting, to a CU, an indication that the first UE has been configured with the inter-UE CLI configuration.

In a ninth aspect, alone or in combination with one or more of the first through eighth aspects, the inter-UE CLI configuration is associated with L1/L2 inter-UE CLI.

In a tenth aspect, alone or in combination with one or more of the first through ninth aspects, the inter-UE CLI configuration is via L3 signaling.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a first network node or an apparatus of a first network node, in accordance with the present disclosure. Example process 1500 is an example where the apparatus or the first network node (e.g., first network node 110) performs operations associated with backhaul signaling for inter-UE CLI mitigation.

As shown in FIG. 15, in some aspects, process 1500 may include transmitting, to a first UE, a UL RS configuration (block 1510). For example, the first network node (e.g., using transmission component 2004 and/or communication manager 2006, depicted in FIG. 20) may transmit, to a first UE, a UL RS configuration, as described above.

As further shown in FIG. 15, in some aspects, process 1500 may include transmitting, to a second network node, the UL RS configuration (block 1520). For example, the first network node (e.g., using transmission component 2004 and/or communication manager 2006, depicted in FIG. 20) may transmit, to a second network node, the UL RS configuration, as described above.

As further shown in FIG. 15, in some aspects, process 1500 may include receiving a UL RS measurement report from the first UE (block 1530). For example, the first network node (e.g., using reception component 2002 and/or communication manager 2006, depicted in FIG. 20) may receive a UL RS measurement report from the first UE, as described above.

As further shown in FIG. 15, in some aspects, process 1500 may include transmitting the UL RS measurement report to the first network node (block 1540). For example, the first network node (e.g., using transmission component 2004 and/or communication manager 2006, depicted in FIG. 20) may transmit the UL RS measurement report to the first network node, as described above.

Process 1500 may include additional aspects, such as any single aspect or any combination of aspects described below and/or in connection with one or more other processes described elsewhere herein.

In a first aspect, process 1500 includes receiving, from the second network node, an inter-UE CLI configuration for a second UE.

In a second aspect, alone or in combination with the first aspect, process 1500 includes receiving an inter-UE CLI report from the second network node, the inter-UE CLI report being associated with a second UE.

In a third aspect, alone or in combination with one or more of the first and second aspects, process 1500 includes configuring the first UE to reduce a transmit power.

In a fourth aspect, alone or in combination with one or more of the first through third aspects, process 1500 includes transmitting, to the second network node, a mitigation policy.

In a fifth aspect, alone or in combination with one or more of the first through fourth aspects, the mitigation policy identifies one or more of a power backoff, one or more transmit beams, one or more receive beams, a guard band, a timing adjustment, one or more aggressor UEs, a most interfering beam, or a least interfering beam.

In a sixth aspect, alone or in combination with one or more of the first through fifth aspects, process 1500 includes receiving, from a DU, an indication that the first UE has been configured with an inter-UE CLI configuration.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, at a first network node or an apparatus of a first network node, in accordance with the present disclosure. Example process 1600 is an example where the apparatus or the first network node (e.g., first network node 110) performs operations associated with backhaul signaling to mitigate inter-gNB CLI.

As shown in FIG. 16, in some aspects, process 1600 may include transmitting an inter-gNB CLI measurement configuration to a second network node (block 1610). For example, the first network node (e.g., using transmission component 2004 and/or communication manager 2006, depicted in FIG. 20) may transmit an inter-gNB CLI measurement configuration to a second network node, as described above.

As further shown in FIG. 16, in some aspects, process 1600 may include receiving an inter-gNB CLI report from the second network node (block 1620). For example, the first network node (e.g., using reception component 2002 and/or communication manager 2006, depicted in FIG. 20) may receive an inter-gNB CLI report from the second network node, as described above.

As further shown in FIG. 16, in some aspects, process 1600 may include mitigating inter-gNB CLI between the first network node and the second network node (block 1630). For example, the first network node (e.g., using communication manager 2006, depicted in FIG. 20) may mitigate inter-gNB CLI between the first network node and the second network node, as described above.

Process 1600 may include additional aspects, such as any single aspect or any combination of aspects described below and/or in connection with one or more other processes described elsewhere herein.

In a first aspect, mitigating the inter-gNB CLI includes reducing a transmission power.

In a second aspect, alone or in combination with the first aspect, process 1600 includes transmitting the inter-gNB CLI report to a third network node.

In a third aspect, alone or in combination with one or more of the first and second aspects, the inter-gNB CLI configuration includes one or more of a measurement configuration identifier, one or more CLI measurement resources, a CLI measurement trigger, a CLI measurement periodicity, a CLI measurement window, a CLI measurement type, a CLI reporting trigger, an indication for measuring one or more of leakage or direct interference, an indication for filtering the CLI measurement, or an indication for instantaneous CLI measurement.

In a fourth aspect, alone or in combination with one or more of the first through third aspects, the one or more CLI measurement resources include one or more of a time resource, a frequency resource, a spatial resource, a list of synchronization signal blocks, a list of channel state information reference signal resources, or a list of downlink channel demodulation reference signal resources.

In a fifth aspect, alone or in combination with one or more of the first through fourth aspects, process 1600 includes measuring a CLI periodically or upon a triggering event.

In a sixth aspect, alone or in combination with one or more of the first through fifth aspects, the triggering event includes a radio strength being above a threshold.

In a seventh aspect, alone or in combination with one or more of the first through sixth aspects, the triggering event includes a radio strength being below a threshold.

In an eighth aspect, alone or in combination with one or more of the first through seventh aspects, the inter-gNB CLI report includes one or more inter-gNB CLI measurements.

In a ninth aspect, alone or in combination with one or more of the first through eighth aspects, the inter-gNB CLI report includes one or more of a measurement configuration identifier, one or more network node identifiers, one or more beam identifiers, one or more sub-band identifiers, an indication of a most aggressor sub-band, an indication of a least aggressor sub-band, an indication of a most aggressor network node, an indication of a least aggressor network node, an indication of a most interfering beam, an indication of a least interfering beam, an indication that a CLI measured is leakage, an indication that the CLI measured is caused by direct interference, or an indication of a CLI report type.

In a tenth aspect, alone or in combination with one or more of the first through ninth aspects, process 1600 includes transmitting the inter-gNB CLI report periodically or upon a triggering event.

In an eleventh aspect, alone or in combination with one or more of the first through tenth aspects, the triggering event includes a radio strength being above a threshold.

In a twelfth aspect, alone or in combination with one or more of the first through eleventh aspects, the triggering event includes a radio strength being below a threshold.

In a thirteenth aspect, alone or in combination with one or more of the first through twelfth aspects, the first network node is one of a CU or a DU.

In a fourteenth aspect, alone or in combination with one or more of the first through thirteenth aspects, the second network node is one of a CU or a DU.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a first network node or an apparatus of a first network node, in accordance with the present disclosure. Example process 1700 is an example where the apparatus or the first network node (e.g., first network node 110) performs operations associated with backhaul signaling to mitigate inter-gNB CLI.

As shown in FIG. 17, in some aspects, process 1700 may include transmitting a reference signal measurement configuration request to a second network node (block 1710). For example, the first network node (e.g., using transmission component 2004 and/or communication manager 2006, depicted in FIG. 20) may transmit a reference signal measurement configuration request to a second network node, as described above.

As further shown in FIG. 17, in some aspects, process 1700 may include receiving a reference signal measurement configuration response, the reference signal measurement configuration response including a reference signal measurement configuration for the second network node (block 1720). For example, the first network node (e.g., using reception component 2002 and/or communication manager 2006, depicted in FIG. 20) may receive a reference signal measurement configuration response, the reference signal measurement configuration response including a reference signal measurement configuration for the second network node, as described above.

As further shown in FIG. 17, in some aspects, process 1700 may include measuring a channel using the reference signal measurement configuration response (block 1730). For example, the first network node (e.g., using communication manager 2006, depicted in FIG. 20) may measure a channel using the reference signal measurement configuration response, as described above.

As further shown in FIG. 17, in some aspects, process 1700 may include transmitting a channel measurement report to the second network node (block 1740). For example, the first network node (e.g., using transmission component 2004 and/or communication manager 2006, depicted in FIG. 20) may transmit a channel measurement report to the second network node, as described above.

Process 1700 may include additional aspects, such as any single aspect or any combination of aspects described below and/or in connection with one or more other processes described elsewhere herein.

In a first aspect, the reference signal measurement configuration request includes one or more of a transaction identifier, a reference signal configuration identifier, a request to transmit the reference signal measurement configuration periodically, or a request to transmit a reference signal upon an event trigger.

In a second aspect, alone or in combination with the first aspect, the reference signal measurement configuration response includes one or more of a transaction identifier or one or more requested reference signal details.

In a third aspect, alone or in combination with one or more of the first and second aspects, the one or more requested reference signal details includes one or more of a reference signal type, one or more time resources during which a reference signal was transmitted, one or more frequency resources on which the reference signal was transmitted, one or more spatial resources on which the reference signal was transmitted, an indication of whether the reference signal was transmitted periodically or upon an event trigger, or reference signal measurement details.

In a fourth aspect, alone or in combination with one or more of the first through third aspects, the channel measurement report includes one or more of a channel estimate, a channel measurement, a channel interference, a covariance matrix, or channel measurement methodology details.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, at a first network node or an apparatus of a first network node, in accordance with the present disclosure. Example process 1800 is an example where the apparatus or the first network node (e.g., first network node 110) performs operations associated with backhaul signaling to exchange muting information.

As shown in FIG. 18, in some aspects, process 1800 may include transmitting a muting request to a second network node (block 1810). For example, the first network node (e.g., using transmission component 2004 and/or communication manager 2006, depicted in FIG. 20) may transmit a muting request to a second network node, as described above.

As further shown in FIG. 18, in some aspects, process 1800 may include receiving a muting information response from the second network node, the muting information response identifying one or more resources (block 1820). For example, the first network node (e.g., using reception component 2002 and/or communication manager 2006, depicted in FIG. 20) may receive a muting information response from the second network node, the muting information response identifying one or more resources, as described above.

As further shown in FIG. 18, in some aspects, process 1800 may include transmitting, to a UE, a schedule for communicating via the resources identified in the muting information response (block 1830). For example, the first network node (e.g., using transmission component 2004 and/or communication manager 2006, depicted in FIG. 20) may transmit, to a UE, a schedule for communicating via the resources identified in the muting information response, as described above.

Process 1800 may include additional aspects, such as any single aspect or any combination of aspects described below and/or in connection with one or more other processes described elsewhere herein.

In a first aspect, process 1800 includes transmitting, to a third network node, one or more of the muting information response or the schedule.

In a second aspect, alone or in combination with the first aspect, the first network node is one of a CU or a DU.

In a third aspect, alone or in combination with one or more of the first and second aspects, the second network node is one of a CU or a DU.

In a fourth aspect, alone or in combination with one or more of the first through third aspects, the muting request indicates a muting information type or a request to mute one or more time resources, one or more frequency resources, or one or more spatial resources.

In a fifth aspect, alone or in combination with one or more of the first through fourth aspects, the muting information response indicates one or more muted, rate-matched, or punctured time resources, one or more muted, rate-matched, or punctured frequency resources, or one or more nulled or beamformed spatial resources.

In a sixth aspect, alone or in combination with one or more of the first through fifth aspects, the muting information response includes one or more of cell-specific muting information, beam-specific muting information, UE-specific muting information, or area-specific muting information.

In a seventh aspect, alone or in combination with one or more of the first through sixth aspects, the muting information response indicates a muting pattern.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram of an example apparatus 1900 for wireless communication, in accordance with the present disclosure. The apparatus 1900 may be a UE, or a UE may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 140 described in connection with FIG. 1. As shown, the apparatus 1900 may communicate with another apparatus 1908, such as a UE or a network node (such as a CU, a DU, an RU, or a base station), using the reception component 1902 and the transmission component 1904.

In some aspects, the apparatus 1900 may be configured to perform one or more operations described herein in connection with FIGS. 4-12. Additionally, or alternatively, the apparatus 1900 may be configured to perform one or more processes described herein, such as process 1300 of FIG. 13. In some aspects, the apparatus 1900 and/or one or more components shown in FIG. 19 may include one or more components of the UE described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1904 may be co-located with the reception component 1902 in one or more transceivers.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The reception component 1902 may receive, from a first network node, an inter-UE CLI configuration. The transmission component 1904 may transmit an inter-UE CLI report to the first network node or to a second network node.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

FIG. 20 is a diagram of an example apparatus 2000 for wireless communication, in accordance with the present disclosure. The apparatus 2000 may be a network node, or a network node may include the apparatus 2000. In some aspects, the apparatus 2000 includes a reception component 2002, a transmission component 2004, and/or a communication manager 2006, which may be in communication with one another (for example, via one or more buses and/or one or more other components). In some aspects, the communication manager 2006 is the communication manager 150 described in connection with FIG. 1. As shown, the apparatus 2000 may communicate with another apparatus 2008, such as a UE or a network node (such as a CU, a DU, an RU, or a base station), using the reception component 2002 and the transmission component 2004.

In some aspects, the apparatus 2000 may be configured to perform one or more operations described herein in connection with FIGS. 4-12. Additionally, or alternatively, the apparatus 2000 may be configured to perform one or more processes described herein, such as process 1400 of FIG. 14, process 1500 of FIG. 15, process 1600 of FIG. 16, process 1700 of FIG. 17, process 1800 of FIG. 18, or a combination thereof. In some aspects, the apparatus 2000 and/or one or more components shown in FIG. 20 may include one or more components of the network node described in connection with FIG. 2. Additionally, or alternatively, one or more components shown in FIG. 20 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2002 may receive communications, such as reference signals, control information, data communications, or a combination thereof, from the apparatus 2008. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 2002 and/or the transmission component 2004 may include or may be included in a network interface. The network interface may be configured to obtain and/or output signals for the apparatus 2000 via one or more communications links, such as a backhaul link, a midhaul link, and/or a fronthaul link.

The transmission component 2004 may transmit communications, such as reference signals, control information, data communications, or a combination thereof, to the apparatus 2008. In some aspects, one or more other components of the apparatus 2000 may generate communications and may provide the generated communications to the transmission component 2004 for transmission to the apparatus 2008. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2008. In some aspects, the transmission component 2004 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 2004 may be co-located with the reception component 2002 in one or more transceivers.

The communication manager 2006 may support operations of the reception component 2002 and/or the transmission component 2004. For example, the communication manager 2006 may receive information associated with configuring reception of communications by the reception component 2002 and/or transmission of communications by the transmission component 2004. Additionally, or alternatively, the communication manager 2006 may generate and/or provide control information to the reception component 2002 and/or the transmission component 2004 to control reception and/or transmission of communications.

In some aspects, the transmission component 2004 may transmit, to a first UE, an inter-UE CLI configuration. The transmission component 2004 may transmit the inter-gNB CLI configuration to a second network node serving a second UE. The reception component 2002 may receive an inter-UE CLI report from the first UE. The transmission component 2004 may transmit the inter-UE CLI report to the second network node. The communication manager 2006 may grant, to the first UE, resources associated with low inter-UE CLI. The reception component 2002 may receive, from the second network node, an SRS configuration or UL RS configuration for the second UE. The communication manager 2006 may determine the inter-UE CLI configuration in accordance with the SRS or UL RS configuration for the second UE.

In some aspects, the transmission component 2004 may transmit, to the second network node, the inter-UE CLI report. The transmission component 2004 may transmit, to the second network node, the inter-UE CLI configuration. The transmission component 2004 may transmit, to the second network node, a mitigation policy. The transmission component 2004 may transmit, to a CU, an indication that the first UE has been configured with the inter-UE CLI configuration. The transmission component 2004 may transmit, to a first UE, a UL RS configuration. The transmission component 2004 may transmit, to a second network node, the UL RS configuration. The reception component 2002 may receive an uplink reference signal measurement report from the first UE. The transmission component 2004 may transmit the uplink reference signal measurement report to the first network node. The reception component 2002 may receive, from the second network node, an inter-UE CLI configuration for a second UE. The reception component 2002 may receive an inter-UE CLI report from the second network node, the inter-UE CLI report being associated with a second UE. The communication manager 2006 may configure the first UE to reduce a transmit power. The transmission component 2004 may transmit, to the second network node, a mitigation policy. The reception component 2002 may receive, from a DU, an indication that the first UE has been configured with an inter-UE CLI configuration.

In some aspects, the transmission component 2004 may transmit an inter-gNB CLI measurement configuration to a second network node. The reception component 2002 may receive an inter-gNB CLI report from the second network node. The communication manager 2006 may mitigate inter-gNB CLI between the first network node and the second network node. The transmission component 2004 may transmit the inter-gNB CLI report to a third network node. The communication manager 2006 may measure a CLI periodically or upon a triggering event. The transmission component 2004 may transmit the inter-gNB CLI report periodically or upon a triggering event.

In some aspects, the transmission component 2004 may transmit a reference signal measurement configuration request to a second network node. The reception component 2002 may receive a reference signal measurement configuration response, the reference signal measurement configuration response including a reference signal measurement configuration for the second network node. The communication manager 2006 may measure a channel using the reference signal measurement configuration response. The transmission component 2004 may transmit a channel measurement report to the second network node.

In some aspects, the transmission component 2004 may transmit a muting request to a second network node. The reception component 2002 may receive a muting information response from the second network node, the muting information response identifying one or more resources. The transmission component 2004 may transmit, to a UE, a schedule for communicating via the resources identified in the muting information response. The transmission component 2004 may transmit, to a third network node, one or more of the muting information response or the schedule.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

The following provides an overview of some Aspects of the present disclosure:

Aspect 1: A method of wireless communication performed by a first UE, comprising: receiving, from a first network node, an inter-UE CLI configuration; and transmitting an inter-UE CLI report to the first network node or to a second network node.

Aspect 2: The method of Aspect 1, wherein the inter-UE CLI configuration includes rules for measuring interference between the first UE and a second UE, and wherein the inter-UE CLI configuration is received via L1/L2 signaling.

Aspect 3: The method of any of Aspects 1-2, wherein the inter-UE CLI report is associated with interference between the first UE and a second UE, and wherein the inter-UE CLI report is transmitted to the first network node or to the second network node via L1/L2 signaling.

Aspect 4: A method of wireless communication performed by a first network node, comprising: transmitting, to a first UE, an inter-UE CLI configuration;
transmitting the inter-UE CLI configuration to a second network node serving a second UE; receiving an inter-UE CLI report from the first UE; and transmitting the inter-UE CLI report to the second network node.

Aspect 5: The method of Aspect 4, further comprising granting, to the first UE, resources associated with low inter-UE CLI.

Aspect 6: The method of any of Aspects 4-5, further comprising receiving, from the second network node, an SRS configuration or UL RS configuration for the second UE.

Aspect 7: The method of Aspect 6, further comprising determining the inter-UE CLI configuration in accordance with the SRS or uplink reference signal configuration for the second UE.

Aspect 8: The method of any of Aspects 4-7, further comprising transmitting, to the second network node, the inter-UE CLI report.

Aspect 9: The method of any of Aspects 4-8, further comprising transmitting, to the second network node, the inter-UE CLI configuration.

Aspect 10: The method of any of Aspects 4-9, further comprising transmitting, to the second network node, a mitigation policy.

Aspect 11: The method of Aspect 10, wherein the mitigation policy identifies one or more of a power backoff, one or more transmit beams, one or more receive beams, a guard band, a timing adjustment, one or more aggressor UEs, a most interfering beam, or a least interfering beam.

Aspect 12: The method of Aspect 10, further comprising transmitting, to a CU, an indication that the first UE has been configured with the inter-UE CLI configuration.

Aspect 13: The method of Aspect 12, wherein the inter-UE CLI configuration is transmitted via L1/L2 signaling or L3 signaling.

Aspect 14: A method of wireless communication performed by a first network node, comprising: transmitting, to a first UE, an UL RS configuration; transmitting, to a second network node, the UL RS configuration; receiving a UL RS measurement report from the first UE; and transmitting the UL RS measurement report to the first network node.

Aspect 15: The method of Aspect 14, further comprising receiving, from the second network node, an inter-UE CLI configuration for a second UE.

Aspect 16: The method of any of Aspects 14-15, further comprising receiving an inter-UE CLI report from the second network node, the inter-UE CLI report being associated with a second UE.

Aspect 17: The method of any of Aspects 14-16, further comprising configuring the first UE to reduce a transmit power.

Aspect 18: The method of any of Aspects 14-17, further comprising transmitting, to the second network node, a mitigation policy.

Aspect 19: The method of Aspect 18, wherein the mitigation policy identifies one or more of a power backoff, one or more transmit beams, one or more receive beams, a guard band, a timing adjustment, one or more aggressor UEs, a most interfering beam, or a least interfering beam.

Aspect 20: The method of any of Aspects 14-19, further comprising receiving, from a DU, an indication that the first UE has been configured with an inter-UE CLI configuration.

Aspect 21: The method of Aspect 12, wherein the inter-UE CLI configuration is transmitted via L3 signaling.

Aspect 22: A method of wireless communication performed by a first network node, comprising: transmitting an inter-gNB CLI measurement configuration to a second network node; receiving an inter-gNB CLI report from the second network node; and mitigating inter-gNB CLI between the first network node and the second network node.

Aspect 23: The method of Aspect 22, wherein mitigating the inter-gNB CLI includes reducing a transmission power.

Aspect 24: The method of any of Aspects 22-23, further comprising transmitting the inter-gNB CLI report to a third network node.

Aspect 25: The method of any of Aspects 22-24, wherein the inter-gNB CLI configuration includes one or more of a measurement configuration identifier, one or more CLI measurement resources, a CLI measurement trigger, a CLI measurement periodicity, a CLI measurement window, a CLI measurement type, a CLI reporting trigger, an indication for measuring one or more of leakage or direct interference, an indication for filtering the CLI measurement, or an indication for instantaneous CLI measurement.

Aspect 26: The method of Aspect 25, wherein the one or more CLI measurement resources include one or more of a time resource, a frequency resource, a spatial resource, a list of synchronization signal blocks, a list of channel state information reference signal resources, or a list of downlink channel demodulation reference signal resources.

Aspect 27: The method of any of Aspects 22-26, further comprising measuring a CLI periodically or upon a triggering event.

Aspect 28: The method of Aspect 27, wherein the triggering event includes a radio strength being above a threshold.

Aspect 29: The method of Aspect 27, wherein the triggering event includes a radio strength being below a threshold.

Aspect 30: The method of any of Aspects 22-29, wherein the inter-gNB CLI report includes one or more inter-gNB CLI measurements.

Aspect 31: The method of any of Aspects 22-30, wherein the inter-gNB CLI report includes one or more of a measurement configuration identifier, one or more network node identifiers, one or more beam identifiers, one or more sub-band identifiers, an indication of a most aggressor sub-band, an indication of a least aggressor sub-band, an indication of a most aggressor network node, an indication of a least aggressor network node, an indication of a most interfering beam, an indication of a least interfering beam, an indication that a CLI measured is caused by leakage, an indication that the CLI measured is caused by direct interference, or an indication of a CLI report type.

Aspect 32: The method of any of Aspects 22-31, further comprising transmitting the inter-gNB CLI report periodically or upon a triggering event.

Aspect 33: The method of Aspect 32, wherein the triggering event includes a radio strength being above a threshold.

Aspect 34: The method of Aspect 32, wherein the triggering event includes a radio strength being below a threshold.

Aspect 35: The method of any of Aspects 22-34, wherein the first network node is one of a CU or a DU.

Aspect 36: The method of any of Aspects 22-35, wherein the second network node is one of a CU or a DU.

Aspect 37: A method of wireless communication performed by a first network node, comprising: transmitting a reference signal measurement configuration request to a second network node; receiving a reference signal measurement configuration response, the reference signal measurement configuration response including a reference signal measurement configuration for the second network node; measuring a channel using the reference signal measurement configuration response; and transmitting a channel measurement report to the second network node.

Aspect 38: The method of Aspect 37, wherein the reference signal measurement configuration request includes one or more of a transaction identifier, a reference signal configuration identifier, a request to transmit the reference signal measurement configuration periodically, or a request to transmit a reference signal upon an event trigger.

Aspect 39: The method of any of Aspects 37-38, wherein the reference signal measurement configuration response includes one or more of a transaction identifier or one or more requested reference signal details.

Aspect 40: The method of Aspect 39, wherein the one or more requested reference signal details includes one or more of a reference signal type, one or more time resources during which a reference signal was transmitted, one or more frequency resources on which the reference signal was transmitted, one or more spatial resources on which the reference signal was transmitted, an indication of whether the reference signal was transmitted periodically or upon an event trigger, or reference signal measurement details.

Aspect 41: The method of any of Aspects 37-40, wherein the channel measurement report includes one or more of a channel estimate, a channel measurement, a channel interference, a covariance matrix, or channel measurement methodology details.

Aspect 42: A method of wireless communication performed by a first network node, comprising: transmitting a muting request to a second network node; receiving a muting information response from the second network node, the muting information response identifying one or more resources; and transmitting, to a user equipment (UE), a schedule for communicating via the resources identified in the muting information response.

Aspect 43: The method of Aspect 42, further comprising transmitting, to a third network node, one or more of the muting information response or the schedule.

Aspect 44: The method of any of Aspects 42-43, wherein the first network node is one of a CU or a DU.

Aspect 45: The method of any of Aspects 42-44, wherein the second network node is one of a CU or a DU.

Aspect 46: The method of any of Aspects 42-45, wherein the muting request indicates a muting information type or a request to mute one or more time resources, one or more frequency resources, or one or more spatial resources.

Aspect 47: The method of any of Aspects 42-46, wherein the muting information response indicates one or more muted, rate-matched, or punctured time resources, one or more muted, rate-matched, or punctured frequency resources, or one or more nulled or beamformed spatial resources.

Aspect 48: The method of any of Aspects 42-47, wherein the muting information response includes one or more of cell-specific muting information, beam-specific muting information, UE-specific muting information, or area-specific muting information.

Aspect 49: The method of any of Aspects 42-48, wherein the muting information response indicates a muting pattern.

Aspect 50: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-49.

Aspect 51: An apparatus for wireless communication at a device, the apparatus comprising one or more memories and one or more processors coupled to the one or more memories, the one or more processors configured to cause the device to perform the method of one or more of Aspects 1-49.

Aspect 52: An apparatus for wireless communication, the apparatus comprising at least one means for performing the method of one or more of Aspects 1-49.

Aspect 53: A non-transitory computer-readable medium storing code for wireless communication, the code comprising instructions executable by one or more processors to perform the method of one or more of Aspects 1-49.

Aspect 54: A non-transitory computer-readable medium storing a set of instructions for wireless communication, the set of instructions comprising one or more instructions that, when executed by one or more processors of a device, cause the device to perform the method of one or more of Aspects 1-49.

Aspect 55: A device for wireless communication, the device comprising a processing system that includes one or more processors and one or more memories coupled with the one or more processors, the processing system configured to cause the device to perform the method of one or more of Aspects 1-49.

Aspect 56: An apparatus for wireless communication at a device, the apparatus comprising one or more memories and one or more processors coupled to the one or more memories, the one or more processors individually or collectively configured to cause the device to perform the method of one or more of Aspects 1-49.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A first network node for wireless communication, comprising:
one or more memories; and
one or more processors, coupled to the one or more memories, configured to cause the first network node to:
transmit, to a first user equipment (UE), an inter-UE cross-link interference (CLI) configuration;
transmit the inter-UE CLI configuration to a second network node serving a second UE;
receive an inter-UE CLI report from the first UE; and
transmit the inter-UE CLI report to the second network node.

2. The first network node of claim 1, wherein the one or more processors are further configured to cause the first network node to grant, to the first UE, resources associated with low inter-UE CLI.

3. The first network node of claim 1, wherein the one or more processors are further configured to cause the first network node to receive, from the second network node, a sounding reference signal (SRS) configuration or uplink reference signal configuration for the second UE.

4. The first network node of claim 3, wherein the one or more processors are further configured to cause the first network node to determine the inter-UE CLI configuration in accordance with the SRS or uplink reference signal configuration for the second UE.

5. The first network node of claim 1, wherein the one or more processors are further configured to cause the first network node to transmit, to the second network node, the inter-UE CLI report.

6. The first network node of claim 1, wherein the one or more processors are further configured to cause the first network node to transmit, to the second network node, the inter-UE CLI configuration.

7. The first network node of claim 1, wherein the one or more processors are further configured to cause the first network node to transmit, to the second network node, a mitigation policy.

8. The first network node of claim 7, wherein the mitigation policy identifies one or more of a power backoff, one or more transmit beams, one or more receive beams, a guard band, a timing adjustment, one or more aggressor UEs, a most interfering beam, or a least interfering beam.

9. The first network node of claim 7, wherein the one or more processors are further configured to cause the first network node to transmit, to a central unit (CU), an indication that the first UE has been configured with the inter-UE CLI configuration.

10. The first network node of claim 1, wherein the inter-UE CLI configuration is transmitted via one or more of Layer 1/Layer 2 (L1/L2) signaling or Layer 3 (L3) signaling.

11. A first network node for wireless communication, comprising:
one or more memories; and
one or more processors, coupled to the one or more memories, configured to cause the first network node to:
transmit, to a first user equipment (UE), an uplink reference signal configuration;
transmit, to a second network node, the uplink reference signal configuration;
receive an uplink reference signal measurement report from the first UE; and
transmit the uplink reference signal measurement report to the first network node.

12. The first network node of claim 11, wherein the one or more processors are further configured to cause the first network node to receive, from the second network node, an inter-UE cross-link interference (CLI) configuration for a second UE.

13. The first network node of claim 11, wherein the one or more processors are further configured to cause the first network node to receive an inter-UE cross-link interference (CLI) report from the second network node, the inter-UE CLI report being associated with a second UE.

14. The first network node of claim 11, wherein the one or more processors are further configured to cause the first network node to configure the first UE to reduce a transmit power.

15. The first network node of claim 11, wherein the one or more processors are further configured to cause the first network node to transmit, to the second network node, a mitigation policy, wherein the mitigation policy identifies one or more of a power backoff, one or more transmit beams, one or more receive beams, a guard band, a timing adjustment, one or more aggressor UEs, a most interfering beam, or a least interfering beam.

16. The first network node of claim 11, wherein the one or more processors are further configured to cause the first network node to receive, from a distributed unit (DU), an indication that the first UE has been configured with an inter-UE cross-link interference (CLI) configuration.

17. A first network node for wireless communication, comprising:
one or more memories; and
one or more processors, coupled to the one or more memories, configured to cause the first network node to:
transmit an inter-gNB cross-link interference (CLI) measurement configuration to a second network node;
receive an inter-gNB CLI report from the second network node; and
mitigate inter-gNB CLI between the first network node and the second network node.

18. The first network node of claim 17, wherein the one or more processors, to cause the first network node to mitigate the inter-gNB CLI, are configured to cause the first network node to reduce a transmission power.

19. The first network node of claim 17, wherein the one or more processors are further configured to cause the first network node to transmit the inter-gNB CLI report to a third network node.

20. The first network node of claim 17, wherein the inter-gNB CLI configuration includes one or more of a measurement configuration identifier, one or more CLI measurement resources, a CLI measurement trigger, a CLI measurement periodicity, a CLI measurement window, a CLI measurement type, a CLI reporting trigger, an indication for measuring one or more of leakage or direct interference, an indication for filtering the CLI measurement, or an indication for instantaneous CLI measurement.

21. The first network node of claim 17, wherein the one or more processors are further configured to cause the first network node to measure a CLI periodically or upon a triggering event.

22. The first network node of claim 17, wherein the inter-gNB CLI report includes one or more inter-gNB CLI measurements.

23. The first network node of claim 17, wherein the inter-gNB CLI report includes one or more of a measurement configuration identifier, one or more network node identifiers, one or more beam identifiers, one or more sub-band identifiers, an indication of a most aggressor sub-band, an indication of a least aggressor sub-band, an indication of a most aggressor network node, an indication of a least aggressor network node, an indication of a most interfering beam, an indication of a least interfering beam, an indication that a CLI measured is caused by leakage, an indication that the CLI measured is caused by direct interference, or an indication of a CLI report type.

24. The first network node of claim 17, wherein the one or more processors are further configured to cause the first network node to transmit the inter-gNB CLI report periodically or upon a triggering event.

25. The first network node of claim 17, wherein the first network node is one of a central unit (CU) or a distributed unit (DU).

26. The first network node of claim 17, wherein the second network node is one of a central unit (CU) or a distributed unit (DU).

27. A first network node for wireless communication, comprising:
one or more memories; and
one or more processors, coupled to the one or more memories, configured to cause the first network node to:
transmit a reference signal measurement configuration request to a second network node;
receive a reference signal measurement configuration response, the reference signal measurement configuration response including a reference signal measurement configuration for the second network node;
measure a channel using the reference signal measurement configuration response; and
transmit a channel measurement report to the second network node.

28. The first network node of claim 27, wherein the reference signal measurement configuration request includes one or more of a transaction identifier, a reference signal configuration identifier, a request to transmit the reference signal measurement configuration periodically, or a request to transmit a reference signal upon an event trigger.

29. The first network node of claim 27, wherein the reference signal measurement configuration response includes one or more of a transaction identifier or one or more requested reference signal details.

30. The first network node of claim 27, wherein the channel measurement report includes one or more of a channel estimate, a channel measurement, a channel interference, a covariance matrix, or channel measurement methodology details.
